(19) United States
(12) Patent Application Publication
(10) Pub. No.: US 2025/0358690 A1
(43) Pub. Date: Nov. 20, 2025

(54) Method and Apparatus for Application Context Relocation

(71) Applicant: Telefonaktiebolaget LM Ericsson (publ), Stockholm (SE)

(72) Inventor: Wenliang Xu, Shanghai (CN)

(21) Appl. No.: 18/873,080

(22) PCT Filed: May 17, 2023
(86) PCT No.: PCT/CN2023/094754

§ 371 Date: Dec. 9, 2024

(30) Foreign Application Priority Data
Jun. 14, 2022 (WO) PCT/CN2022/098685

(51) Int. Cl. H04W 36/00; H04L 61/4511; H04W 8/00

(52) U.S. Cl. CPC H04W 36/0033; H04L 61/4511; H04W 8/005

(57) ABSTRACT

Embodiments of the present disclosure provide method and apparatus for application context relocation. A method performed by a cloud application server (CAS) comprises receiving a first request from an edge enabler server (EES) selected for an edge enabler client (EEC) of a user equipment (UE) during a procedure of application context relocation (ACR) or after the EES receiving an edge application server (EAS) information provisioning request. The first request comprises endpoint information of the EES. The method further comprises storing the endpoint information of the EES.

### TECHNICAL FIELD

The non-limiting and exemplary embodiments of the present disclosure generally relate to the technical field of communications, and specifically to methods and apparatuses for application context relocation (ACR).

### BACKGROUND

This section introduces aspects that may facilitate a better understanding of the disclosure. Accordingly, the statements of this section are to be read in this light and are not to be understood as admissions about what is in the prior art or what is not in the prior art.

Edge computing is a concept that enables services to be hosted close to the service consumers and provides benefits such as efficient service delivery with significant reduction in end-to-end latency and decreased load on the transport network. The benefits of edge computing will strengthen the promise of fifth generation (5G) and expand the prospects for several new and enhanced use cases-including virtual and augmented reality, Internet of Things (IoT), Industrial IoT, autonomous driving, real-time multiplayer gaming, etc.

In 3rd Generation Partnership Project (3GPP) Release 17, 3GPP aims to provide native support of edge computing in 3GPP networks. These efforts include initiatives across several working groups in 3GPP including SA6, SA2, SA3, SA4 and SA5, which cover application layer architecture, core network enhancement, security, media processing, and management aspects respectively.

SA6 initiated normative specification work on the architecture for enabling Edge Applications (EDGEAPP). The objective of the work is to define an enabling layer to facilitate communication between the application clients (AC) running on the user equipment (UE) and the edge application servers (EAS) deployed on the edge data network. This includes aspects of service provisioning and EAS discovery. In addition, the work aims to provide support services such as application context transfer between EASs for service continuity, service enablement and capability exposure Application Programming Interfaces (APIs) towards the EAS.

3GPP Technical Specification (TS) 23.558 V17.3.0 and V18.2.0, the disclosure of which is incorporated by reference herein in its entirety, specifies application layer architecture, procedures and information flows necessary for enabling edge applications over 3GPP networks. It includes architectural requirements for enabling edge applications, application layer architecture fulfilling the architecture requirements and procedures to enable the deployment of edge applications.

FIG. 1a shows a reference point representation of the architecture for edge enabling applications. FIG. 1a is same as Figure 6.2-4 of 3GPP TS 23.558 V17.3.0. The Edge Data Network (EDN) is a local Data Network. Edge Application Server(s) (EAS) and the Edge Enabler Server (EES) are contained within the EDN. The Edge Configuration Server provides configurations related to the EES, including details of the Edge Data Network hosting the edge enabler server. The UE contains Application Client(s) (ACs) and the Edge Enabler Client (EEC). The Edge Application Server(s), the Edge Enabler Server and the Edge Configuration Server may interact with the 3GPP core network.

The functional entities include:

Edge Enabler Server (EES): EES provides supporting functions needed for EASs and EEC, e.g., EEC registration, EAS discovery and network APIs for EAS and service continuity support.

Edge Enabler Client (EEC): EEC provides supporting functions needed for AC(s), e.g., retrieval and provisioning of configuration information to enable application data traffic, and EAS discovery.

Edge Configuration Server (ECS): ECS provides supporting functions needed for the EEC to connect with an EES, e.g., provisioning of Edge configuration information to the EEC, and EES discovery.

Application Client (AC): AC is the application resident in the UE performing the client function.

Edge Application Server (EAS): EAS is the application server resident in the EDN, performing the server functions. The AC connects to the EAS in order to avail the services of the application with the benefits of Edge Computing.

Note: EDGE reference point explanation can be found in clause 6.5 of 3GPP TS 23.558 V17.3.0.

In 3GPP TR 23.700-98 V1.0.0, the disclosure of which is incorporated by reference herein in its entirety, there is a key issue (KI) #11 describing issues related to application context relocation (ACR) between the Cloud Application Server (CAS) and EAS.

When a UE moves to a new location, different EASs or CAS can be more suitable for serving the ACs in the UE. Such transitions can result from a non-mobility event also, requiring support to maintain the continuity of the service.

This key issue is to support service continuity for ACs in the UE to minimize service interruption while switching the application server between Edge and Cloud. To support service continuity, the application context is transferred between EAS and CAS.

In 3GPP Release 17, Edge Computing work is limited to the service continuity between the EAS(s) and identified several scenarios for service continuity. Detailed study is required to enable service continuity between EAS and CAS, covering the following open issues:
1. Whether and how to detect that ACR is required between EAS and CAS,
2. Whether and how to decide that ACR is required between EAS and CAS,
3. Whether and how to perform ACR between EAS and CAS,
4. Whether and how to perform post ACR actions,
5. Whether EEL is required on the cloud deployment and what are the potential impacts to the CAS architecture,
6. Whether and what are the impacts of CAS initiated ACR.

There are two solutions for this KI, solution 24 of 3GPP TR 23.700-98 V1.0.0 is with CES (Central Enabler Server) and solution 25 of 3GPP TR 23.700-98 V1.0.0 is without CES.

For solution 25 of 3GPP TR 23.700-98 V1.0.0, because there is no CES supporting CAS, clause 6.5 in 3GPP TR 23.700-98 V1.0.0 describes the architecture option for supporting CAS utilizing EES.

FIG. 1b shows architecture with Cloud Application Server (CAS). FIG. 1b is same as Figure 6.5.1-1 of 3GPP TR 23.700-98 V1.0.0.

Compared to the EDGEAPP (3GPP Rel-17) architecture, new entity Cloud Application Server is proposed along with the new reference points EDGE-14 (between EES and CAS), EDGE-15 (between ECS and CAS) and EDGE-16 (between 3GPP Core Network and CAS).

In this solution, the Cloud Application Server (CAS) interaction with EES is supported via EDGE-14 reference point and CAS is supported by ECS via EDGE-15 reference point. The CAS and EAS interaction is supported as Application Data Traffic. The CAS interaction with the 3GPP core network happens over EDGE-16 reference point, which is similar to EDGE-7 reference point.

Since the EAS may have service area restriction, once the UE is moving out of the current edge coverage, to keep service continuity, the application client needs to connect to either another EAS in new EDN or the CAS.

The architecture supports ACR between edge and cloud deployments for the following conditions:
Condition 1: For the locations where EDN is not available, the ACR support is based on the failed Service provisioning response (i.e. the non-availability of the EDN at a particular location) from the ECS.
Condition 2: When AC profiles are sent in Service provisioning request and particular EAS is not available then EDN non-availability for that EAS is inferred through Service provisioning response.
Condition 3: For the locations where EDN is available but the EAS is not available, the ACR support is based on the indication from the EES (in the EAS discovery response) about the non-availability of the EAS at that particular location.
Condition 4: EAS and EDN are available but EAS is overloaded or not in a position to serve the EEC/UE due to any reason.
Condition 5: For a UE location, when CAS is serving and a suitable EAS is available at the edge, ACR can be initiated for continuing the service delivery via EAS.

FIG. 1c shows the architecture for enabling cloud applications along with the edge applications. FIG. 1c is same as Figure 6.2c-1 of 3GPP TS 23.558 V18.2.0.

CAS residing outside the EDN may need to interact with the EEL entities e.g. for service continuity. Compared to the architecture of FIG. 1b, new entity Notification Management client and Notification Management server are proposed and some reference points are renamed.

### Notification Management Client

The notification management client functional entity acts as the application client for notification management aspects. It interacts with the notification management server. It handles the notification messages received from the notification management server and deliver it to the corresponding Vertical Application Layer (VAL) clients residing on the VAL UE.

The notification management (NM) client functional entity is supported by the Hyper Text Transfer Protocol (HTTP) client functional entities of the signaling control plane.

### Notification Management Server

The notification management server is a functional entity that handles the notification management aspects by interacting with the notification management client and the VAL servers. The notification management server receives the notification messages from the vertical application layer and delivers it to the notification management client.

The reference points of the architecture for enabling edge applications may comprise:
EDGE-1 reference point enables interactions between the EES and the EEC,
EDGE-2 reference point enables interactions between the EES and the 3GPP Core Network functions and APIs for retrieval of network capability information,
EDGE-3 reference point enables interactions between the EES and the EASs,
EDGE-4 reference point enables interactions between the ECS and the EEC,
EDGE-5 reference point enables interactions between AC(s) and the EEC,
EDGE-6 reference point enables interactions between the ECS and the EES,
EDGE-7 reference point enables interactions between the EAS and the 3GPP Core Network functions and APIs for retrieval of network capability information,
EDGE-8 reference point enables interactions between the ECS and the 3GPP Core Network functions and APIs for retrieval of network capability information,
EDGE-9 reference point enables interactions between two EESs,
NM-UU: The interactions related to notification management functions between the notification management client and the notification management server are supported by NM-UU reference point. This reference point utilizes Uu reference point as described in 3GPP TS 23.401 V18.1.0 and 3GPP TS 23.501 V18.0.0,
NM-C: The interactions related to notification management functions between the VAL client(s) and the notification management client within a VAL UE are supported by NM-C (client) reference point,
NM-S: The interactions related to notification management functions between the VAL server(s) and the notification management server are supported by NM-S (server) reference point,
ECI-1 (or EDGE-14) enables interaction between CAS and EES,
ECI-2 (or EDGE-15) enables interaction between CAS and ECS, and
CLOUD-3 (or EDGE-16) enables interaction between CAS and the 3GPP core network.

3GPP Technical Specification Groups-Service and System Aspects (TSG-SA) Working Group 6 (WG6) Meeting #54-e, S6-231633, 17-26 Apr. 2023, describes enabling ACR with CAS-S-EES executed ACR.

FIG. 1d shows a flowchart of enabling ACR with CAS-S-EES executed ACR. FIG. 1d is same as the Figure 8.8.2A.5-1 of S6-231633.

FIG. 1d illustrates the S-EES detecting, deciding and executing ACR from the S-EAS to the CAS. This may include EELManagedACR by S-EES when initiated by S-EAS as per clause 8.8.3.6 of 3GPP TS 23.558 V18.2.0.

This scenario description is same as described for clause 8.8.2.5 of 3GPP TS 23.558 V18.2.0 except for the following clarifications:

Pre-conditions: Same pre-conditions apply described for Figure 8.8.2.5-1 of 3GPP TS 23.558 V18.2.0, with the clarification that T-EAS is CAS.

1. Same as step 1 described for Figure 8.8.2.5-1 of 3GPP TS 23.558 V18.2.0.

### Phase I: ACR Detection

2. Same as step 2 described for Figure 8.8.2.5-1 of 3GPP TS 23.558 V18.2.0.

### Phase II: ACR Decision

3. Same as step 3 described for Figure 8.8.2.5-1 of 3GPP TS 23.558 V18.2.0.

4 Same as step 4 described for Figure 8.8.2.5-1 of 3GPP TS 23.558 V18.2.0.

### Phase III: ACR Execution

5. The S-EES determines the targets via the Discover T-EAS procedure in clause 8.8.3.2 of 3GPP TS 23.558 V18.2.0.

6. Same as step 7 described for Figure 8.8.2.5-1 of 3GPP TS 23.558 V18.2.0.

7. The S-EES may apply the AF traffic influence with the N6 routing information of the CAS in the 3GPP Core Network (if applicable).

8. The S-EES sends the ACR management notification (e.g. as notification for “ACR facilitation” event or “application context transfer (ACT) start” event as described in clause 8.6.3 or due to step 1) to the S-EAS to initiate ACT between the S-EAS and the CAS.

9. The Application Context is transferred from S-EAS to the CAS at implementation specific time. In the case of EELManagedACR, the S-EES accesses the Application Context from the address as per step 1 and the S-EES either engage in the ACT from S-EAS to the CAS (obtained as per step 5) in a secure way. Further the CAS accesses the Application Context. The S-EAS may also perform the ACT directly with CAS, the specification of such process is out of scope of the present document.

NOTE 1: The Application Context is encrypted and protected by the application layer. The S-EES engages in the packet level transport of the Application Context and has no visibility to the content of the Application Context.

NOTE 2: The S-EAS or CAS can further decide to terminate the ACR, and the CAS can discard the application context based on information received from EEL and/or other methods (e.g. monitoring the location of the UE). It is up to the implementation of the S-EAS and CAS whether and how to make such a decision.

Phase IV: Post-ACR Clean up

10. Same as step 11 described for Figure 8.8.2.5-1 of 3GPP TS 23.558 V18.2.0.

11. Same as step 12 described for Figure 8.8.2.5-1 of 3GPP TS 23.558 V18.2.0.

12. If the status in step 11 indicates a successful ACT, the S-EES sends the ACR information notification (ACR complete) message to the EEC to confirm that the ACR has completed as specified in clause 8.8.3.5.3 of 3GPP TS 23.558 V18.2.0.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There are some issues for the ACR between the CAS and EAS.

As a first example, in a case when the 1st ACR happens, the application context is transferred from the 1st EAS to the CAS. Then the 2nd ACR is triggered by the CAS to relocate application context from the CAS to the 2nd EAS. The issue is that it is unknown how CAS can know the EES information (the EES is used to serve the 1st EAS) so that the T-EAS discovery procedure and subsequent EAS selection declaration procedure can be exchanged between the CAS and the EES. The EES may have EEC context information maintained so such EEC context can be pushed to the 2nd EES that is serving the selected T-EAS (i.e. the 2nd EAS).

This issue is also documented as Editor's Note in clause 7.25.2.2.5 of 3GPP TR 23.700-98 V1.0.0. Editor's Note: How CAS knows the EES is for future study (FFS).

There are several ways to inform CAS about the EES used to serve the EAS having application function (AF) session with AC. One of those is to share it from AC to CAS, but this puts a burden on both the AC and CAS (of course, EEC is also impacted to supply EES information to AC).

As a second example, in a case when the 1st ACR (i.e. from edge to cloud) happens, the application context is transferred from the 1st EAS (served by the 1st EES) to the CAS, then the 2nd ACR (i.e. from cloud to edge) is triggered by the CAS to relocate Application context from the CAS to the 2nd EAS (served by the 2nd EES). NOTE: the 2nd EAS and the 1st EAS can be the same EAS. For the 2nd ACR, it can be detected and triggered by the CAS.

In clause 7.25.2.2.6.1 (EES discovery via service provision triggering) of the TR 23.700-98 V18.1.0, the disclosure of which is incorporated by reference herein in its entirety, the proposed solution has extra impact to AC and EAS. The EEC selected T-EES may not be the final T-EES to serve the T-EAS, i.e. the CAS may select a T-EAS which is served by a different T-EES than EEC selected T-EES.

In clause 7.25.2.2.6.2 (CAS initiated ACR via ECS) of the TR 23.700-98 V18.1.0, even though it is the same entity (i.e. the CAS) performing the T-EES retrieval and T-EAS discovery, but the proposed solution has the problem of not taking care of the EEC context information maintained in the 1st EES which was used to serve the 1st EAS.

A solution is to let the same entity (i.e. the CAS) contact the 1st EES for T-EAS discovery so that the EEC context information in the 1st EES can also be relocated to the 2nd EES, which serves the selected T-EAS (i.e. the 2nd EAS). The issue is that it is unknown how the CAS can know the 1st EES information.

Similar problem exists in the 1st ACR (i.e. from edge to cloud) under the S-EES executed ACR (see FIG. 1d). The pre-condition for step 10 of FIG. 1d to happen is that the CAS has subscribed to the S-EES with ACR management event. But the CAS doesn't know which EES (i.e. the 1st EES) is used to serve the EEC so it cannot perform subscription.

In service continuity between edge and cloud w/o CES, the CAS is not aware of the serving EES selected in edge, therefore, the CAS is unable to utilize the needed EEL service for instance subscribe to receive ACT status notifications in S-EES executed ACR scenario for EELManagedACR and/or trigger CAS decided ACR.

To overcome or mitigate at least one above mentioned problems or other problems, an improved solution for application context relocation may be desirable.

In an embodiment, to reduce the impact for the application over the top, it is proposed to allow the EES to inform CAS about its presence during the ACR from EAS to CAS.

In an embodiment, EES may store the serving EES information in the central repository so that the CAS can obtain the serving EES information or be notified about the serving EES information from the central repository.

In a first aspect of the disclosure, there is provided a method performed by a cloud application server (CAS). The method may comprise receiving a first request from an edge enabler server (EES) selected for an edge enabler client (EEC) of a user equipment (UE) during a procedure of application context relocation (ACR) or after the EES receiving an edge application server (EAS) information provisioning request. The first request may comprise endpoint information of the EES. The method may further comprise storing the endpoint information of the EES.

In an embodiment, the endpoint information of the EES may comprise at least one of Uniform Resource Identifier (URI), Fully Qualified Domain Name (FQDN), or Internet protocol address.

In an embodiment, the first request may be a selected EES declaration request.

In an embodiment, the method may further comprise sending a first response to the EES.

In an embodiment, the ACR may be between edge application server (EAS) and CAS.

In an embodiment, the ACR may be initiated by an edge enabler client (EEC) using regular EAS discovery.

In an embodiment, the ACR may be executed by EEC via the EES.

In an embodiment, the ACR may be decided by a source EAS.

In an embodiment, the ACR may be executed by the EES.

In an embodiment, the endpoint information of the EES may be used by the CAS to communicate with the EES to start a target EAS discovery procedure.

In an embodiment, the CAS may be found out via Domain Name System (DNS) query/discovery.

In a second aspect of the disclosure, there is provided a method performed by an edge enabler server (EES) selected for an edge enabler client (EEC) of a user equipment (UE). The method may comprise sending a first request to a cloud application server (CAS) during a procedure of application context relocation (ACR) or after the EES receiving an edge application server (EAS) information provisioning request. The first request may comprise endpoint information of the EES.

In an embodiment, the endpoint information of the EES may comprise at least one of Uniform Resource Identifier (URI), Fully Qualified Domain Name (FQDN), or Internet protocol address.

In an embodiment, the first request may be a selected EES declaration request.

In an embodiment, the method may further comprise receiving a first response from the CAS.

In an embodiment, the ACR may be between edge application server (EAS) and CAS.

In an embodiment, the ACR may be initiated by an edge enabler client (EEC) using regular EAS discovery.

In an embodiment, the ACR may be executed by EEC via the EES.

In an embodiment, the ACR may be decided by a source EAS.

In an embodiment, the ACR may be executed by the EES.

In an embodiment, the endpoint information of the EES may be used by the CAS to communicate with the EES to start a target EAS discovery procedure.

In an embodiment, the method may further comprise receiving a first ACR request from an edge enabler client (EEC). The first ACR request may comprise information indicating that EES informs the CAS with the endpoint information of the EES.

In an embodiment, the method may further comprise receiving a selected CAS declaration message from a source EAS. The selected CAS declaration message informs the EES a determined CAS to use.

In an embodiment, the method may further comprise determining that no relevant EAS is available for a location of a user equipment. The method may further comprise determining the CAS.

In an embodiment, the CAS may be found out via Domain Name System (DNS) query/discovery.

In a third aspect of the disclosure, there is provided a method performed by an edge enabler client (EEC). The method may comprise sending a first application context relocation (ACR) request to an edge enabler server (EES) selected for an edge enabler client (EEC) of a user equipment (UE) during a procedure of ACR. The first ACR request may comprise information indicating that EES informs a cloud application server (CAS) with endpoint information of the EES.

In an embodiment, the endpoint information of the EES may comprise at least one of Uniform Resource Identifier (URI), Fully Qualified Domain Name (FQDN), or Internet protocol address.

In an embodiment, the ACR may be between edge application server (EAS) and CAS.

In an embodiment, the ACR may be initiated by an edge enabler client (EEC) using regular EAS discovery.

In an embodiment, the ACR may be executed by EEC via the EES.

In an embodiment, the endpoint information of the EES may be used by the CAS to communicate with the EES to start a target EAS discovery procedure.

In an embodiment, the method may further comprise receiving a second ACR request from an application client (AC). The second ACR request may comprise information indicating that an included target EAS is CAS.

In an embodiment, the method may further comprise the CAS may be found out via Domain Name System (DNS) query/discovery.

In a fourth aspect of the disclosure, there is provided a method performed by an application client (AC). The method may comprise determining a cloud application server (CAS). The method may further comprise sending a second application context relocation (ACR) request to an edge enabler client (EEC) during a procedure of ACR. The second ACR request may comprise information indicating that an included target edge application server (EAS) is CAS.

In an embodiment, the CAS may be found out via Domain Name System (DNS) query/discovery.

In an embodiment, the ACR may be initiated by an edge enabler client (EEC) using regular EAS discovery.

In an embodiment, the ACR may be executed by EEC via the EES.

In an embodiment, the ACR may be between edge application server (EAS) and CAS.

In a fifth aspect of the disclosure, there is provided a cloud application server (CAS). The CAS may comprise a processor and a memory coupled to the processor. Said memory contains instructions executable by said processor. The CAS is operative to receive a first request from an edge enabler server (EES) selected for an edge enabler client (EEC) of a user equipment (UE) during a procedure of application context relocation (ACR) or after the EES receiving an edge application server (EAS) information provisioning request. The first request may comprise endpoint information of the EES. The CAS is further operative to store the endpoint information of the EES.

In a sixth aspect of the disclosure, there is provided an edge enabler server (EES) selected for an edge enabler client (EEC) of a user equipment (UE). The EES may comprise a processor and a memory coupled to the processor. Said memory contains instructions executable by said processor. The EES may be operative to send a first request to a cloud application server (CAS) during a procedure of application context relocation (ACR) or after the EES receiving an edge application server (EAS) information provisioning request. The first request may comprise endpoint information of the EES.

In a seventh aspect of the disclosure, there is provided an edge enabler client (EEC). The EEC may comprise a processor and a memory coupled to the processor. Said memory contains instructions executable by said processor. The EEC may be operative to send a first application context relocation (ACR) request to an edge enabler server (EES) selected for an edge enabler client (EEC) of a user equipment (UE) during a procedure of ACR. The first ACR request may comprise information indicating that EES informs a cloud application server (CAS) with endpoint information of the EES.

In an eighth aspect of the disclosure, there is provided an application client (AC). The AC may comprise a processor and a memory coupled to the processor. Said memory contains instructions executable by said processor. The AC may be operative to determine a cloud application server (CAS). The AC may be further operative to send a second application context relocation (ACR) request to an edge enabler client (EEC) during a procedure of ACR. The second ACR request may comprise information indicating that an included target edge application server (EAS) is CAS.

In a ninth aspect of the disclosure, there is provided a CAS. The CAS may comprise a receiving module configured to receive a first request from an edge enabler server (EES) selected for an edge enabler client (EEC) of a user equipment (UE) during a procedure of application context relocation (ACR) or after the EES receiving an edge application server (EAS) information provisioning request. The first request may comprise endpoint information of the EES. The CAS may further comprise a storing module configured to store the endpoint information of the EES.

In an embodiment, the CAS may further comprise a sending module configured to send a first response to the EES.

In a tenth aspect of the disclosure, there is provided an EES. The EES may comprise a first sending module configured to send a first request to a cloud application server (CAS) during a procedure of application context relocation (ACR) or after the EES receiving an edge application server (EAS) information provisioning request. The first request may comprise endpoint information of the EES.

In an embodiment, the EES may further comprise a first receiving module configured to receive a first response from the CAS.

In an embodiment, the EES may further comprise a second receiving module configured to receive a first ACR request from an edge enabler client (EEC). The first ACR request may comprise information indicating that EES informs the CAS with the endpoint information of the EES.

In an embodiment, the EES may further comprise a third receiving module configured to receive a selected CAS declaration message from a source EAS. The selected CAS declaration message informs the EES a determined CAS to use.

In an embodiment, the EES may further comprise a first determining module configured to determine that no relevant EAS is available for a location of a user equipment.

In an embodiment, the EES may further comprise a second determining module configured to determine the CAS.

In an eleventh aspect of the disclosure, there is provided an EEC. The EEC may comprise a sending module configured to send a first application context relocation (ACR) request to an edge enabler server (EES) selected for an edge enabler client (EEC) of a user equipment (UE) during a procedure of ACR. The first ACR request may comprise information indicating that EES informs a cloud application server (CAS) with endpoint information of the EES.

In an embodiment, the EEC may further comprise a receiving module configured to receive a second ACR request from an application client (AC). The second ACR request may comprise information indicating that an included target EAS is CAS.

In a twelfth aspect of the disclosure, there is provided an AC. The AC may comprise a determining module configured to determine a cloud application server (CAS). The AC may further comprise a sending module configured to send a second application context relocation (ACR) request to an edge enabler client (EEC) during a procedure of ACR. The second ACR request may comprise information indicating that an included target edge application server (EAS) is CAS.

In a thirteenth aspect of the disclosure, there is provided method performed by a cloud application server (CAS). The method may comprise sending a first request to a central repository. The first request may be used for retrieving information of an edge enabler server (EES) selected for an edge enabler client (EEC) of a user equipment (UE) or subscribing for the information of the EES selected for the EEC of the UE. The method may further comprise receiving a first message from the central repository.

In an embodiment, the first request may comprise at least one of first information for determining the EES selected for the EEC of the UE, a requestor identifier, or security credentials.

In an embodiment, the first request may comprise at least one of first information for determining the EES selected for the EEC of the UE, a requestor identifier, security credentials, a notification target address, or an event identifier.

In an embodiment, the first information may comprise at least one of an edge application server (EAS) identifier, a UE identifier, or an application client (AC) identifier.

In an embodiment, the first request may comprise at least one of a selected EES retrieval request, or a selected EES subscription request.

In an embodiment, the first message may comprise at least one of a selected EES retrieval response, or a selected EES notification.

In an embodiment, when the first message is a selected EES retrieval response, the selected EES retrieval response may comprise at least one of an information element indicating that the first request is successful or failed, the information of the EES selected for the EEC of the UE when the first request is successful, or a failure cause when the first request is failed.

In an embodiment, when the first message is a selected EES notification, the selected EES notification may comprise at least one of a subscription identifier, an event identifier, or the information of the EES selected for the EEC of the UE.

In an embodiment, the method may further comprise storing the information of the EES selected for the EEC of the UE.

In an embodiment, the CAS is serving or going to serve an AC of the UE.

In an embodiment, the information of the EES selected for the EEC of the UE may comprise at least one of a UE identifier, a selected EES identifier, selected EES endpoint information, an EAS identifier, or an AC identifier.

In an embodiment, the endpoint information of the EES selected for the EEC of the UE may comprise at least one of Uniform Resource Identifier (URI), Fully Qualified Domain Name (FQDN), or Internet protocol address.

In an embodiment, the information of the EES selected for the EEC of the UE may be used by the CAS to at least one of communicate with the selected EES to start a target EAS discovery procedure, trigger a service continuity procedure towards the selected EES, subscribe to receive application context transfer status notification, or subscribe to receive application context relocation management notification.

In an embodiment, when the first request is a selected EES subscription request message, the method may further comprise receiving a selected EES subscription response from the central repository.

In an embodiment, the selected EES subscription response may comprise at least one of an information element indicating that the first request is successful or failed, a subscription identifier when the first request is successful, or a failure cause when the first request is failed.

In an embodiment, the central repository may be a standalone server or implemented or co-located in an edge configuration server.

In a fourteenth aspect of the disclosure, there is provided a method performed by a central repository. The method may comprise receiving a first request from a cloud application server (CAS). The first request may be used for retrieving information of an edge enabler server (EES) selected for an edge enabler client, EEC of a user equipment (UE) or subscribing for the information of the EES selected for the EEC of the UE. The method may comprise sending a first message to the CAS.

In an embodiment, the first request may comprise at least one of first information for determining the EES selected for the EEC of the UE, a requestor identifier, or security credentials.

In an embodiment, the first request may comprise at least one of first information for determining the EES selected for the EEC of the UE, a requestor identifier, security credentials, a notification target address, or an event identifier.

In an embodiment, the first information may comprise at least one of an edge application server (EAS) identifier, a UE identifier, or an application client, AC, identifier.

In an embodiment, the first request may comprise at least one of a selected EES retrieval request, or a selected EES subscription request.

In an embodiment, the first message may comprise at least one of a selected EES retrieval response, or a selected EES notification.

In an embodiment, when the first message is a selected EES retrieval response, the selected EES retrieval response may comprise at least one of an information element indicating that the first request is successful or failed, the information of the EES selected for the EEC of the UE when the first request is successful, or a failure cause when the first request is failed.

In an embodiment, when the first message is a selected EES notification, the selected EES notification may comprise at least one of a subscription identifier, an event identifier, or the information of the EES selected for the EEC of the UE.

In an embodiment, the CAS is serving or going to serve an AC of the UE.

In an embodiment, the information of the EES selected for the EEC of the UE may comprise at least one of a UE identifier, a selected EES identifier, selected EES endpoint information, an EAS identifier, or an AC identifier.

In an embodiment, the endpoint information of the EES selected for the EEC of the UE may comprise at least one of Uniform Resource Identifier (URI), Fully Qualified Domain Name (FQDN), or Internet protocol address.

In an embodiment, the information of the EES selected for the EEC of the UE may be used by the CAS to at least one of communicate with the selected EES to start a target EAS discovery procedure, trigger a service continuity procedure towards the selected EES, subscribe to receive application context transfer status notification, or subscribe to receive application context relocation management notification.

In an embodiment, when the first request is a selected EES subscription request message, the method may further comprise sending a selected EES subscription response to the CAS.

In an embodiment, the selected EES subscription response may comprise at least one of an information element indicating that the first request is successful or failed, a subscription identifier when the first request is successful, or a failure cause when the first request is failed.

In an embodiment, the central repository may be a standalone server or implemented or co-located in an edge configuration server.

In an embodiment, when the first request is a selected EES retrieval request, the method may further comprise checking whether the CAS is authorized to perform a retrieving operation.

In an embodiment, when the CAS is authorized to perform the retrieving operation, the first message may comprise a retrieving result.

In an embodiment, when the first request is a selected EES subscription request, the method may further comprise authorizing the first request. The method may further comprise storing event subscription when the first request is authorized.

In an embodiment, the method may further comprise receiving a second request from the EES selected for the EEC of the UE. The second request may comprise the information of the EES selected for the EEC of the UE. The method may further comprise storing the information of the EES selected for the EEC of the UE. The method may further comprise sending a second response to the EES selected for the EEC of the UE.

In an embodiment, the second request may be a selected EES declaration request and/or the second response may be a selected EES declaration response.

In an embodiment, the second request may further comprise security credentials.

In an embodiment, the second request may further comprise checking whether the EES selected for the EEC of the UE is authorized to perform a storing operation.

In an embodiment, when the EES selected for the EEC of the UE is authorized to perform the storing operation, the central repository may store the information of the EES selected for the EEC of the UE.

In an embodiment, the second response may comprise at least one of an information element indicating that the second request is successful or failed, or a failure cause when the second request is failed.

In a fifteenth aspect of the disclosure, there is provided a method performed by an edge enabler server (EES). The method may comprise sending a second request to a central repository. The second request may comprise the information of the EES which is selected for an edge enabler client (EEC) of a user equipment, UE. The method may further comprise receiving a second response from the central repository.

In an embodiment, the second request may be a selected EES declaration request and/or the second response may be a selected EES declaration response.

In an embodiment, the second request may further comprise security credentials.

In an embodiment, the second response may comprise at least one of an information element indicating that the second request is successful or failed, or a failure cause when the second request is failed.

In an embodiment, the information of the EES selected for the EEC of the UE may comprise at least one of a UE identifier, a selected EES identifier, selected EES endpoint information, an edge application server (EAS) identifier, or an AC identifier.

In an embodiment, the endpoint information of the EES selected for the EEC of the UE may comprise at least one of Uniform Resource Identifier (URI), Fully Qualified Domain Name (FQDN), or Internet protocol address.

In an embodiment, the information of the EES selected for the EEC of the UE is used by a CAS to at least one of communicate with the selected EES to start a target EAS discovery procedure, trigger a service continuity procedure towards the selected EES, subscribe to receive application context transfer status notification, or subscribe to receive application context relocation management notification.

In an embodiment, the CAS is serving or going to serve an AC of the UE.

In an embodiment, the central repository may be a standalone server or implemented or co-located in an edge configuration server.

In an embodiment, the second request may be sent to the central repository during a procedure of application context relocation or after the EES receiving an edge application server, EAS, information provisioning request.

In an embodiment, the ACR is initiated by an edge enabler client (EEC) using regular EAS discovery, and/or the ACR is executed by EEC via the EES, and/or the ACR is decided by a source EAS, and/or the ACR is executed by the EES.

In another aspect of the disclosure, there is provided a cloud application server (CAS). The CAS may comprise a processor and a memory coupled to the processor. Said memory contains instructions executable by said processor. The CAS is operative to send a first request to a central repository. The first request is used for retrieving information of an edge enabler server (EES) selected for an edge enabler client (EEC) of a user equipment (UE) or subscribing for the information of the EES selected for the EEC of the UE. The CAS is further operative to receive a first message from the central repository.

In another aspect of the disclosure, there is provided a central repository. The central repository may comprise a processor and a memory coupled to the processor. Said memory contains instructions executable by said processor. The central repository is operative to receive a first request from a cloud application server (CAS). The first request is used for retrieving information of an edge enabler server (EES) selected for an edge enabler client (EEC) of a user equipment (UE) or subscribing for the information of the EES selected for the EEC of the UE. The central repository is further operative to send a first message to the CAS.

In another aspect of the disclosure, there is provided an edge enabler server (EES). The EES may comprise a processor and a memory coupled to the processor. Said memory contains instructions executable by said processor. The EES is operative to send a second request to a central repository. The second request may comprise the information of the EES which is selected for an edge enabler client (EEC) of a user equipment (UE). The EES is further operative to receive a second response from the central repository.

In another aspect of the disclosure, there is provided a CAS. The CAS may comprise a sending module configured to send a first request to a central repository. The first request may be used for retrieving information of an edge enabler server (EES) selected for an edge enabler client (EEC) of a user equipment (UE) or subscribing for the information of the EES selected for the EEC of the UE. The CAS may further comprise a first receiving module configured to receive a first message from the central repository.

In an embodiment, the CAS may further comprise a storing module configured to store the information of the EES selected for the EEC of the UE.

In an embodiment, when the first request is a selected EES subscription request message, the CAS may further comprise a second receiving module configured to receive a selected EES subscription response from the central repository.

In another aspect of the disclosure, there is provided a central repository. The central repository may comprise a first receiving module configured to receive a first request from a cloud application server (CAS). The first request may be used for retrieving information of an edge enabler server (EES) selected for an edge enabler client (EEC) of a user equipment (UE) or subscribing for the information of the EES selected for the EEC of the UE. The central repository may further comprise a first sending module configured to send a first message to the CAS.

In an embodiment, when the first request is a selected EES subscription request message, the central repository may further comprise a second sending module configured to send a selected EES subscription response to the CAS.

In an embodiment, when the first request is a selected EES retrieval request, the central repository may further comprise a first checking module configured to check whether the CAS is authorized to perform a retrieving operation. When the CAS is authorized to perform the retrieving operation, the first message may comprise a retrieving result.

In an embodiment, when the first request is a selected EES subscription request, the central repository may further comprise an authorizing module configured to authorize the first request. The central repository may further comprise a first storing module configured to store event subscription when the first request is authorized.

In an embodiment, the central repository may further comprise a second receiving module configured to receive a second request from the EES selected for the EEC of the UE. The second request may comprise the information of the EES selected for the EEC of the UE. The central repository may further comprise a second storing module configured to storing the information of the EES selected for the EEC of the UE. The central repository may further comprise a third sending module configured to send a second response to the EES selected for the EEC of the UE.

In an embodiment, the central repository may further comprise a second checking module configured to check whether the EES selected for the EEC of the UE is authorized to perform a storing operation. When the EES selected for the EEC of the UE is authorized to perform the storing operation, the central repository may store the information of the EES selected for the EEC of the UE.

In another aspect of the disclosure, there is provided an EES. The EES may comprise a sending module configured to send a second request to a central repository. The second request may comprise the information of the EES which is selected for an edge enabler client (EEC) of a user equipment (UE). The EES may further comprise a receiving module configured to receive a second response from the central repository.

In another aspect of the disclosure, there is provided a computer program product comprising instructions which when executed by at least one processor, cause the at least one processor to perform the method according to any one of the first, second, third, fourth, thirteenth, fourteenth, or fifteenth aspects.

In another aspect of the disclosure, there is provided a computer-readable storage medium storing instructions which when executed by at least one processor, cause the at least one processor to perform the method according to any one of the first, second, third, fourth, thirteenth, fourteenth, or fifteenth aspects.

In another aspect of the disclosure, there is provided a communication system including a host computer. The host computer includes processing circuitry configured to provide user data and a communication interface configured to forward the user data to a cellular network for transmission to a terminal device. The cellular network includes the network node, and/or the terminal device (such as AC and/or EEC above mentioned).

In embodiments of the present disclosure, the system further includes the terminal device. The terminal device is configured to communicate with the network node.

In embodiments of the present disclosure, the processing circuitry of the host computer is configured to execute a host application, thereby providing the user data; and the terminal device includes processing circuitry configured to execute a client application associated with the host application.

In another aspect of the disclosure, there is provided a communication system including a host computer and a network node. The host computer includes a communication interface configured to receive user data originating from a transmission from a terminal device. The transmission is from the terminal device to the network node. The terminal device is above mentioned AC and/or EEC.

In embodiments of the present disclosure, the processing circuitry of the host computer is configured to execute a host application. The terminal device is configured to execute a client application associated with the host application, thereby providing the user data to be received by the host computer.

In another aspect of the disclosure, there is provided a method implemented in a communication system which may include a host computer, a network node and a terminal device. The method may comprise providing user data at the host computer. Optionally, the method may comprise, at the host computer, initiating a transmission carrying the user data to the terminal device via a cellular network comprising the network node.

In another aspect of the disclosure, there is provided a communication system including a host computer. The host computer may comprise processing circuitry configured to provide user data, and a communication interface configured to forward the user data to a cellular network for transmission to a terminal device. The cellular network may comprise a network node having a radio interface and processing circuitry.

In another aspect of the disclosure, there is provided a method implemented in a communication system which may include a host computer, a network node and a terminal device. The method may comprise providing user data at the host computer. Optionally, the method may comprise, at the host computer, initiating a transmission carrying the user data to the terminal device via a cellular network comprising the network node. The terminal device may perform any step of the method according to the third and fourth aspects of the present disclosure.

In another aspect of the disclosure, there is provided a communication system including a host computer. The host computer may comprise processing circuitry configured to provide user data, and a communication interface configured to forward user data to a cellular network for transmission to a terminal device. The terminal device may comprise a radio interface and processing circuitry. The terminal device's processing circuitry may be configured to perform any step of the method according to the third and fourth aspects of the present disclosure.

In another aspect of the disclosure, there is provided a method implemented in a communication system which may include a host computer, a network node and a terminal device. The method may comprise, at the host computer, receiving user data transmitted to the network node from the terminal device which may perform any step of the method according to the third and fourth aspects of the present disclosure.

In another aspect of the disclosure, there is provided a communication system including a host computer. The host computer may comprise a communication interface configured to receive user data originating from a transmission from a terminal device to a network node. The terminal device may comprise a radio interface and processing circuitry. The terminal device's processing circuitry may be configured to perform any step of the method according to the third and fourth aspects of the present disclosure.

In another aspect of the disclosure, there is provided a method implemented in a communication system which may include a host computer, a network node and a terminal device. The method may comprise, at the host computer, receiving, from the network node, user data originating from a transmission which the network node has received from the terminal device.

In another aspect of the disclosure, there is provided a communication system which may include a host computer. The host computer may comprise a communication interface configured to receive user data originating from a transmission from a terminal device to a network node. The network node may comprise a radio interface and processing circuitry.

Embodiments herein may provide many advantages, of which a non-exhaustive list of examples follows. In some embodiments herein, it may enable the CAS to know the selected EES in EDN. In some embodiments herein, it provides functionality in EDGEAPP to support service continuity. In some embodiments herein, it enables the CAS to utilize the needed EEL service for instance subscribe to receive ACT status notifications in S-EES executed ACR scenario for EELManagedACR and/or trigger CAS decided ACR. In some embodiments herein, it solves the issue when CAS needs to relocate application context but doesn't know the EES to start T-EAS discovery and selected T-EAS declaration procedures. In some embodiments herein, it also allows the CAS to contact the EES (e.g. ACR facilitation as described in 3GPP TS 23.558 V17.3.0, clause 8.6.3 and clause 8.8.2.5) to start with EES executed ACR scenario. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a shows a reference point representation of the architecture for edge enabling applications;

FIG. 1b shows architecture with Cloud Application Server (CAS);

FIG. 1c shows the architecture for enabling cloud applications along with the edge applications;

FIG. 1d shows a flowchart of enabling ACR with CAS-S-EES executed ACR;

FIG. 2a schematically shows a high level architecture in the fifth generation network according to an embodiment of the present disclosure;

FIG. 2b schematically shows system architecture in a 4G network according to an embodiment of the present disclosure;

FIG. 3a shows a flowchart of a method according to an embodiment of the present disclosure;

FIG. 3b shows a flowchart of a method according to another embodiment of the present disclosure;

FIG. 3c shows a flowchart of a method according to another embodiment of the present disclosure;

FIG. 3d shows a flowchart of a method according to another embodiment of the present disclosure;

FIG. 4a shows a flowchart of a method according to another embodiment of the present disclosure;

FIG. 4b shows a flowchart of a method according to another embodiment of the present disclosure;

FIG. 4c shows a flowchart of a method according to another embodiment of the present disclosure;

FIG. 4d shows a flowchart of a method according to another embodiment of the present disclosure;

FIG. 4e shows a flowchart of a method according to another embodiment of the present disclosure;

FIG. 4f shows a flowchart of a method according to another embodiment of the present disclosure;

FIG. 4g shows a flowchart of a method according to another embodiment of the present disclosure;

FIG. 4h shows a flowchart of a method according to another embodiment of the present disclosure;

FIG. 4i shows a flowchart of a method according to another embodiment of the present disclosure;

FIG. 4j shows a flowchart of a method according to another embodiment of the present disclosure;

FIG. 4k shows a flowchart of a method according to another embodiment of the present disclosure;

FIG. 5a shows a flowchart of a method according to another embodiment of the present disclosure;

FIG. 5b shows a flowchart of a method according to another embodiment of the present disclosure;

FIG. 6a shows a flowchart of a method according to another embodiment of the present disclosure;

FIG. 6b shows a flowchart of ACR initiated by the EEC and AC according to another embodiment of the present disclosure;

FIG. 6c shows a flowchart of the EEC executing ACR via the S-EES according to another embodiment of the present disclosure;

FIG. 6d shows a flowchart of S-EAS decided ACR according to another embodiment of the present disclosure;

FIG. 6e shows a flowchart of S-EES detecting, deciding and executing ACR from the S-EAS to the CAS according to another embodiment of the present disclosure;

FIG. 6f shows a flowchart of EAS information provisioning according to another embodiment of the present disclosure;

FIG. 6g shows a flowchart of service provisioning and EAS discovery for constraint device according to another embodiment of the present disclosure;

FIG. 6h shows a flowchart of the service continuity from cloud to edge with CAS decided ACR scenario according to another embodiment of the present disclosure;

FIG. 6i shows a flowchart of the service continuity from cloud to edge with old EES executed ACR scenario according to another embodiment of the present disclosure;

FIG. 6j shows a flowchart of the interactions between the EES and the CAS for the selected EES declaration according to another embodiment of the present disclosure;

FIG. 6k shows a flowchart of the interactions between the EES and the central repository for the selected EES declaration according to another embodiment of the present disclosure;

FIG. 6l shows a flowchart of the interactions between the CAS and the central repository for the selected EES retrieval according to another embodiment of the present disclosure;

FIG. 6m shows a flowchart of subscribing selected EES according to another embodiment of the present disclosure;

FIG. 6n shows a flowchart of selected EES subscription notification according to another embodiment of the present disclosure;

FIG. 7 is a block diagram showing an apparatus suitable for practicing some embodiments of the disclosure;

FIG. 8a is a block diagram showing a CAS according to an embodiment of the disclosure;

FIG. 8b is a block diagram showing an EES according to an embodiment of the disclosure;

FIG. 8c is a block diagram showing an EEC according to another embodiment of the disclosure;

FIG. 8d is a block diagram showing an AC according to another embodiment of the disclosure;

FIG. 8e is a block diagram showing a CAS according to another embodiment of the disclosure;

FIG. 8f is a block diagram showing a central repository according to an embodiment of the disclosure;

FIG. 8g is a block diagram showing an EES according to another embodiment of the disclosure;

FIG. 9 is a schematic showing a wireless network in accordance with some embodiments;

FIG. 10 is a schematic showing a user equipment in accordance with some embodiments;

FIG. 11 is a schematic showing a virtualization environment in accordance with some embodiments;

FIG. 12 is a schematic showing a telecommunication network connected via an intermediate network to a host computer in accordance with some embodiments;

FIG. 13 is a schematic showing a host computer communicating via a base station with a user equipment over a partially wireless connection in accordance with some embodiments;

FIG. 14 is a schematic showing methods implemented in a communication system including a host computer, a base station and a user equipment in accordance with some embodiments;

FIG. 15 is a schematic showing methods implemented in a communication system including a host computer, a base station and a user equipment in accordance with some embodiments;

FIG. 16 is a schematic showing methods implemented in a communication system including a host computer, a base station and a user equipment in accordance with some embodiments; and

FIG. 17 is a schematic showing methods implemented in a communication system including a host computer, a base station and a user equipment in accordance with some embodiments.

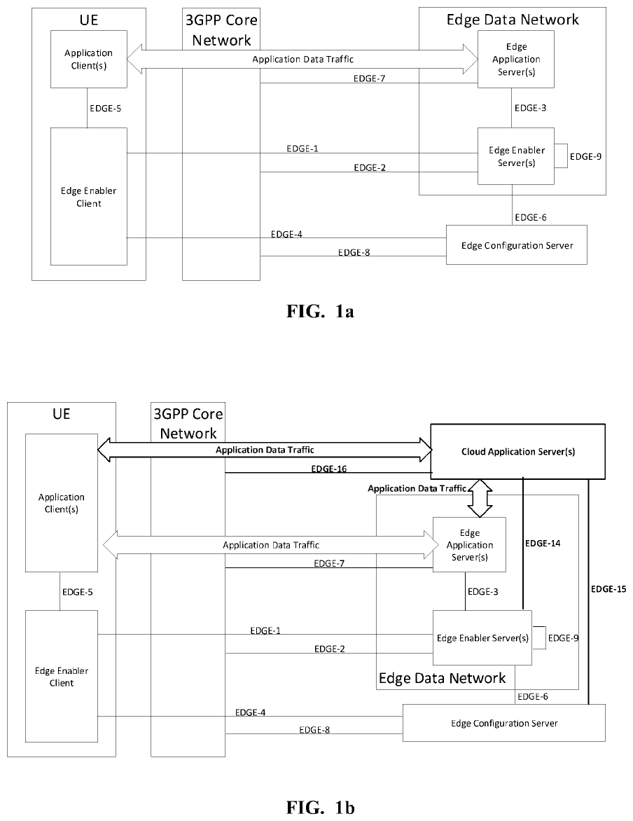

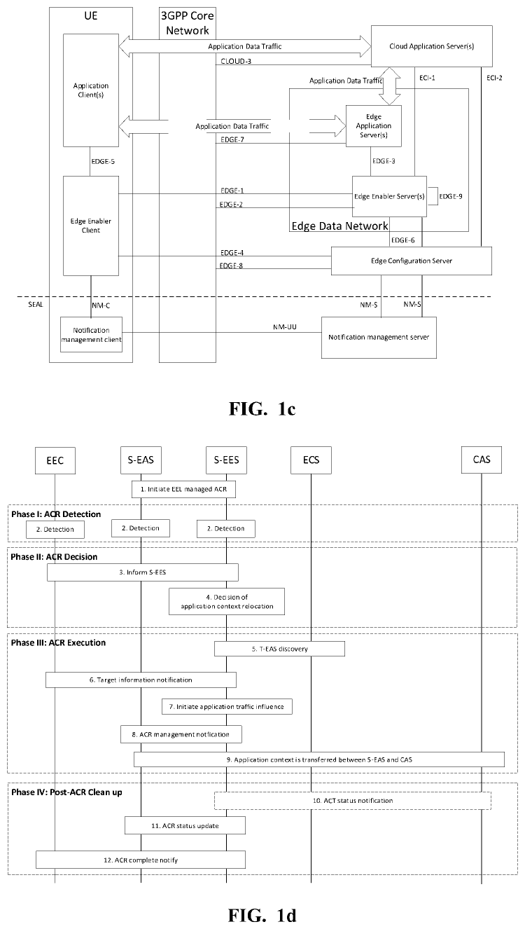

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G, 6G communication protocols, and/or any other protocols either currently known or to be developed in the future.

The term “network device” or “network node” or “network function” refers to any suitable function which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as Access and Mobility Management Function (AMF), Session Management Function (SMF), Authentication Service Function (AUSF), Unified Data Management (UDM), Policy Control Function (PCF), Application Function (AF), Network Exposure Function (NEF), User plane Function (UPF) and Network Repository Function (NRF), radio access network (RAN), service communication proxy (SCP), network data analytics function (NWDAF), Network Slice Selection Function (NSSF), Network Slice-Specific Authentication and Authorization Function (NSSAAF), etc. For example, the 4G system (such as Long Term Evolution (LTE)) may include Mobile Management Entity (MME), home subscriber server (HSS), PCRF (Policy and Charging Rules Function), PGW (Packet Data Network Gateway), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

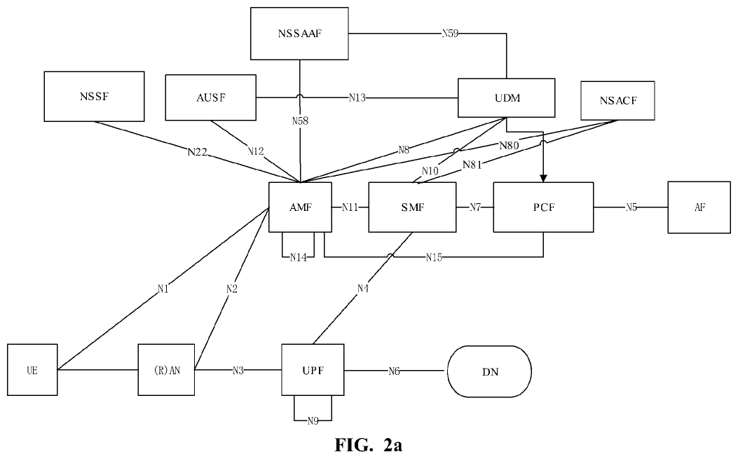

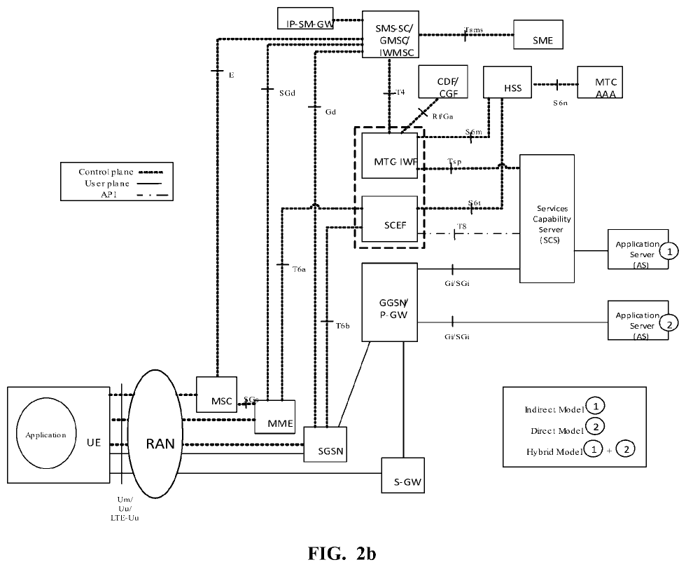

Although the subject matter described herein may be implemented in any appropriate type of system using any suitable components, the embodiments disclosed herein are described in relation to a communication system complied with the exemplary system architectures illustrated in FIGS. 2a-2b. For simplicity, the system architectures of FIGS. 2a-2b only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

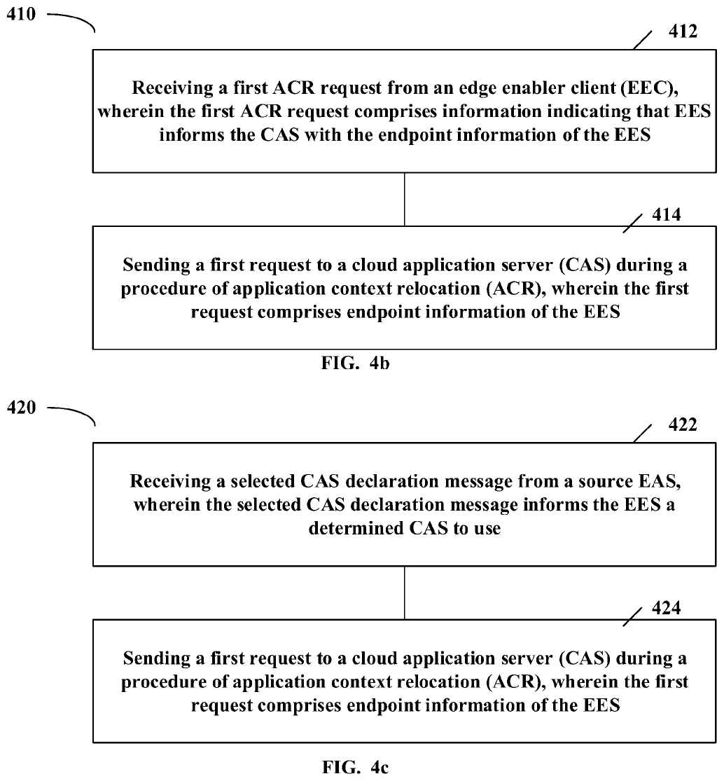

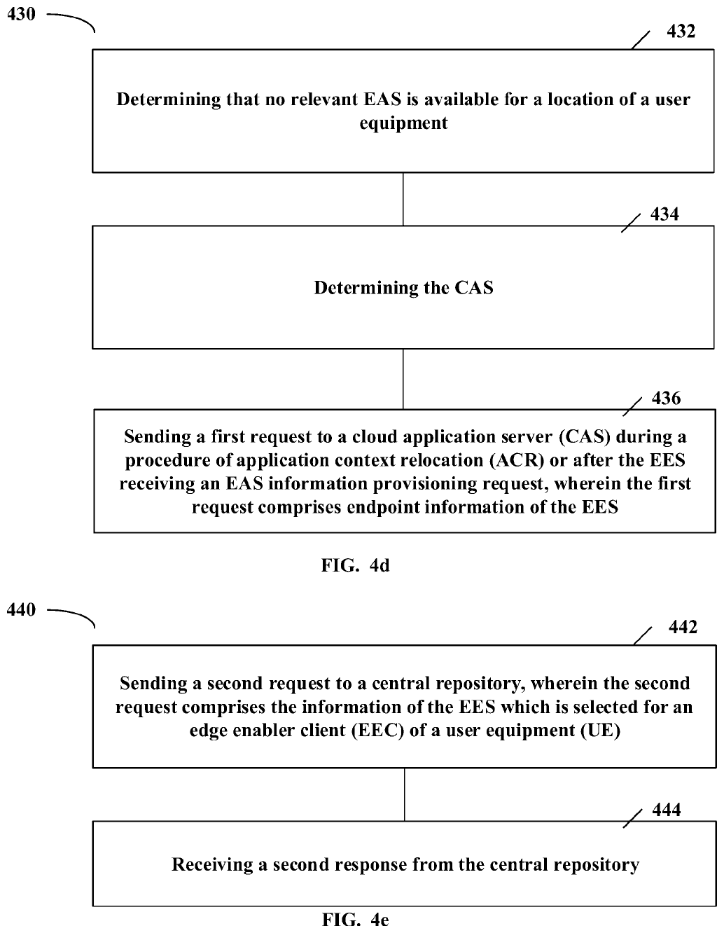

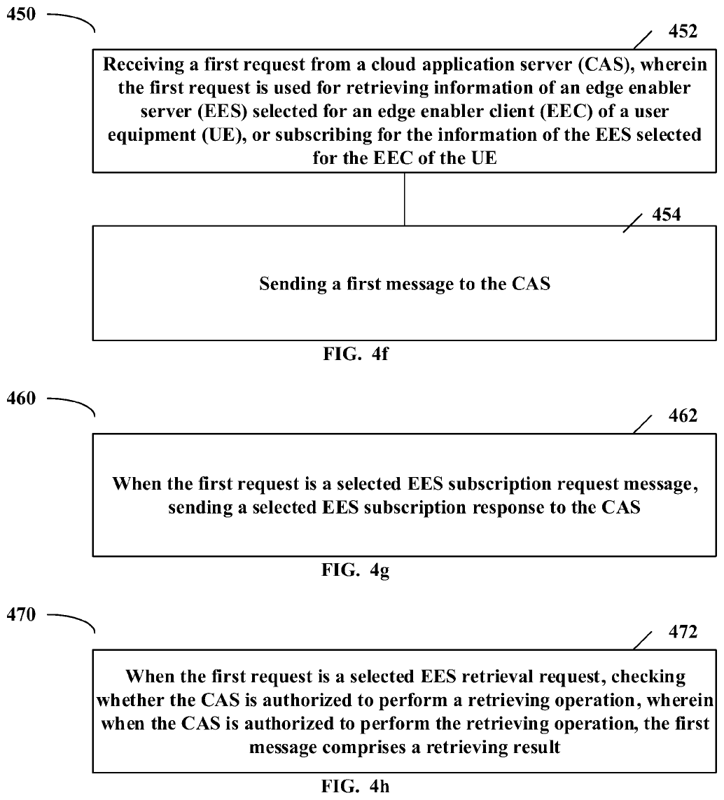

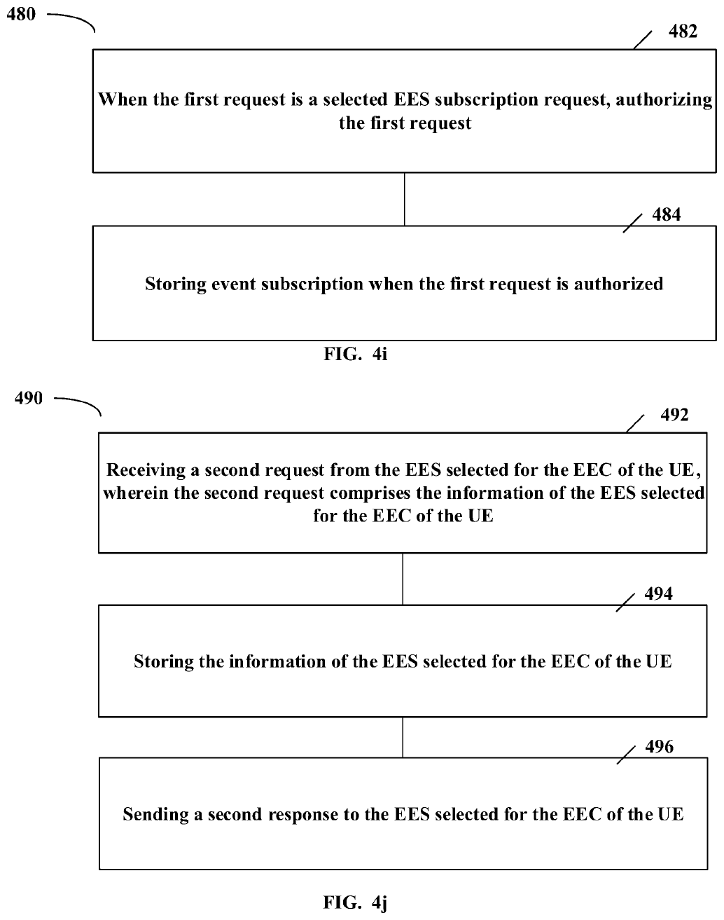

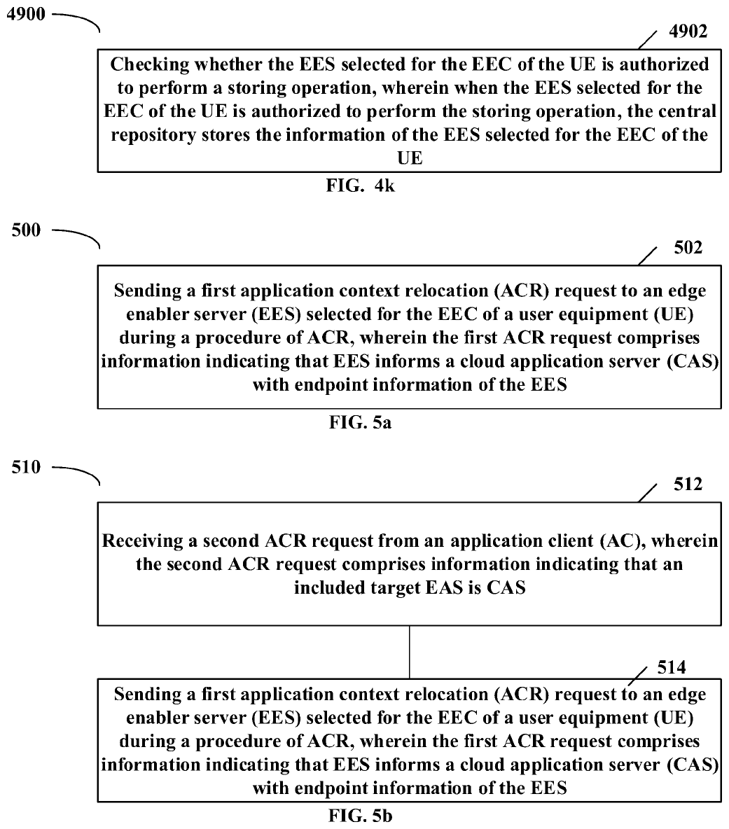

FIG. 2a schematically shows a high level architecture in the fifth generation network according to an embodiment of the present disclosure. For example, the fifth generation network may be 5GS. The architecture of FIG. 2a is same as Figure 4.2.3-2 as described in 3GPP TS 23.501 V17.2.0, the disclosure of which is incorporated by reference herein in its entirety. The system architecture of FIG. 2a may comprise some exemplary elements such as AUSF, AMF, data network (DN), NEF, NRF, NSSF, PCF, SMF, UDM, UPF, AF, UE, (R) AN, Service Communication Proxy (SCP), Network Slice-Specific Authentication and Authorization Function (NSSAAF), Network Slice Admission Control Function (NSACF), etc.

In accordance with an exemplary embodiment, the UE can establish a signaling connection with the AMF over the reference point N1, as illustrated in FIG. 2a. This signaling connection may enable NAS (Non-access stratum) signaling exchange between the UE and the core network, comprising a signaling connection between the UE and the (R) AN and the N2 connection for this UE between the (R) AN and the AMF. The (R) AN can communicate with the UPF over the reference point N3. The UE can establish a protocol data unit (PDU) session to the DN (data network, e.g. an operator network or Internet) through the UPF over the reference point N6.

As further illustrated in FIG. 2a, the exemplary system architecture also contains some reference points such as N1, N2, N3, N4, N6, N9, N15, etc., which can support the interactions between NF services in the NFs. For example, these reference points may be realized through corresponding NF service-based interfaces and by specifying some NF service consumers and providers as well as their interactions in order to perform a particular system procedure. The AM related policy is provided by PCF to AMF for a registered UE via N15 interface. AMF can get AM policy during AM Policy Association Establishment/Modification procedure.

Various NFs shown in FIG. 2a may be responsible for functions such as session management, mobility management, authentication, security, etc. The AUSF, AMF, DN, NEF, NRF, NSSF, PCF, SMF, UDM, UPF, AF, UE, (R) AN, SCP, NSACF may include the functionality for example as defined in clause 6.2 of 3GPP TS 23.501 V17.2.0.

FIG. 2b schematically shows system architecture in a 4G network according to an embodiment of the present disclosure, which is the same as Figure 4.2-1a of 3GPP TS 23.682 V17.2.0, the disclosure of which is incorporated by reference herein in its entirety. The system architecture of FIG. 2b may comprise some exemplary elements such as Services Capability Server (SCS), Application Server (AS), SCEF (Service Capability Exposure Function), HSS, UE, RAN (Radio Access Network), SGSN (Serving GPRS (General Packet Radio Service) Support Node), MME, MSC (Mobile Switching Centre), S-GW (Serving Gateway), GGSN/P-GW (Gateway GPRS Support Node/PDN (Packet Data Network) Gateway), MTC-IWF (Machine Type Communications-InterWorking Function) CDF/CGF (Charging Data Function/Charging Gateway Function), MTC-AAA (Machine Type Communications-authentication, authorization and accounting), SMS-SC/GMSC/IWMSC (Short Message Service-Service Centre/Gateway MSC/InterWorking MSC) IP-SM-GW (Internet protocol Short Message Gateway). The network elements and interfaces as shown in FIG. 2b may be same as the corresponding network elements and interfaces as described in 3GPP TS 23.682 V17.2.0.

The system architecture shows the architecture for a UE used for MTC connecting to the 3GPP network (UTRAN (Universal Terrestrial Radio Access Network), E-UTRAN (Evolved UTRAN), GERAN (GSM EDGE (Enhanced Data rates for GSM Evolution) Radio Access Network), etc.) via the Um/Uu/LTE-Uu interfaces. The system architecture also shows the 3GPP network service capability exposure to SCS and AS.

As further illustrated in FIG. 2b, the exemplary system architecture also contains various reference points.

Tsms: Reference point used by an entity outside the 3GPP network to communicate with UEs used for MTC via SMS (Short Message Service).

Tsp: Reference point used by a SCS to communicate with the MTC-IWF related control plane signalling.

T4: Reference point used between MTC-IWF and the SMS-SC in the HPLMN.

T6a: Reference point used between SCEF and serving MME.

T6b: Reference point used between SCEF and serving SGSN.

T8: Reference point used between the SCEF and the SCS/AS.

S6m: Reference point used by MTC-IWF to interrogate HSS/HLR (Home Location Register).

Son: Reference point used by MTC-AAA to interrogate HSS/HLR.

S6t: Reference point used between SCEF and HSS.

SGs: Reference point used between MSC and MME.

Gi/SGi: Reference point used between GGSN/P-GW and application server and between GGSN/P-GW and SCS.

Rf/Ga: Reference point used between MTC-IWF and CDF/CGF.

Gd: Reference point used between SMS-SC/GMSC/IWMSC and SGSN.

SGd: Reference point used between SMS-SC/GMSC/IWMSC and MME.

E: Reference point used between SMS-SC/GMSC/IWMSC and MSC.

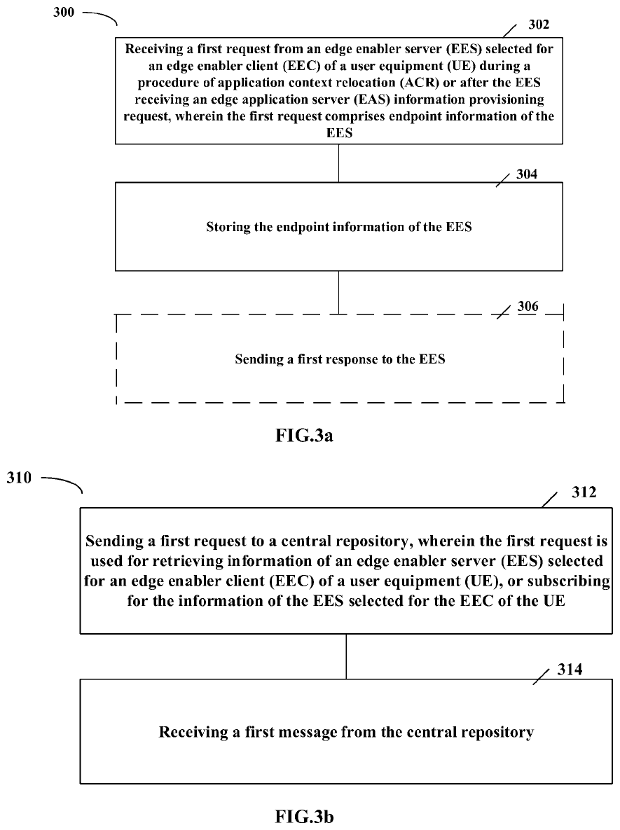

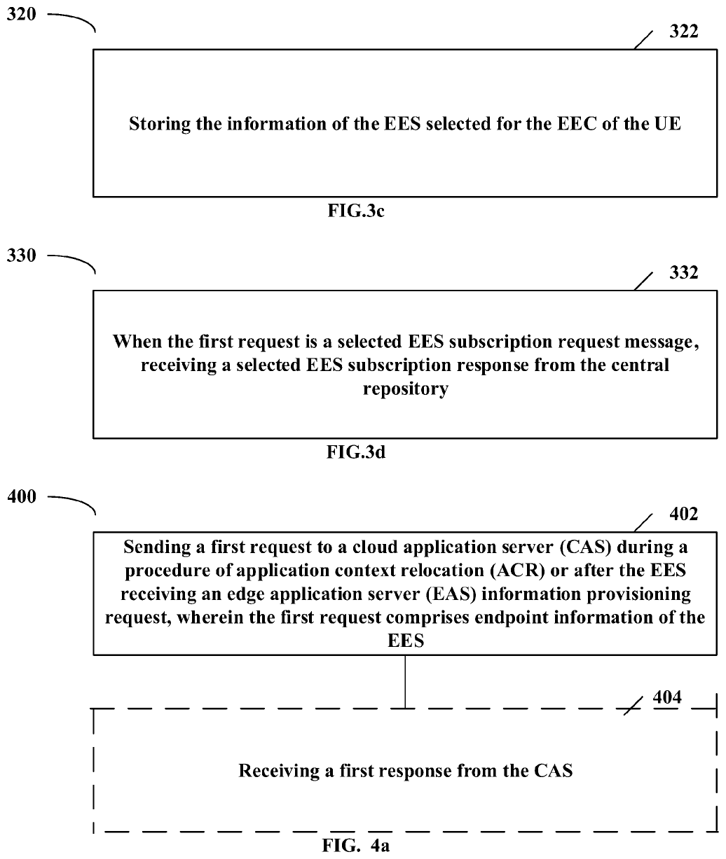

FIG. 3a shows a flowchart of a method according to an embodiment of the present disclosure, which may be performed by an apparatus implemented in or at or as a cloud application server (CAS) or communicatively coupled to the CAS. As such, the apparatus may provide means or modules for accomplishing various parts of the method 300 as well as means or modules for accomplishing other processes in conjunction with other components.

At block 302, the CAS may receive a first request from an edge enabler server (EES) selected for an edge enabler client (EEC) of a user equipment (UE) during a procedure of application context relocation (ACR) or after the EES receiving an edge application server (EAS) information provisioning request. The first request comprises endpoint information of the EES.

In an embodiment, the EES may be a source edge enabler server (S-EES) or an old EES. For example, in the cloud to edge service continuity case, the EES may be an old EES. In the edge to cloud service continuity case, the EES may be an S-EES.

The EAS information provisioning request may be the EAS information provisioning request for example as described in 3GPP TS 23.558 V18.2.0.

In an embodiment, the EES may be same or similar as/to the EES as described in 3GPP TS 23.558 V17.3.0.

In an embodiment, the CAS may be same or similar as/to the EAS as described in 3GPP TR 23.700-98 V1.0.0.

The first request may be any suitable request such as an existing request or a new request.

In an embodiment, the first request may be a selected EES declaration request.

The endpoint information of the EES may comprise any suitable information which can be used to by CAS to communicate with the EES.

In an embodiment, the endpoint information of the EES comprises at least one of Uniform Resource Identifier (URI), Fully Qualified Domain Name (FQDN), or Internet protocol address.

Application context relocation may refer to the end-to-end service continuity procedure as described in clause 8.8 of 3GPP TS 23.558 V17.3.0 or 3GPP TR 23.700-98 V1.0.0.

In an embodiment, the ACR is between edge application server (EAS) and CAS. For example, the application context may be transferred from EAS to CAS or from CAS to EAS.

In an embodiment, the ACR is initiated by an edge enabler client (EEC) using regular EAS discovery for example as described in clause 7.25.2.2.1 of 3GPP TR 23.700-98 V1.0.0.

In an embodiment, the ACR is executed by EEC via the EES for example as described in clause 7.25.2.2.2 of 3GPP TR 23.700-98 V1.0.0.

In an embodiment, the ACR is decided by a source EAS for example as described in clause 7.25.2.2.3 of 3GPP TR 23.700-98 V1.0.0.

In an embodiment, the ACR is executed by the EES for example as described in clause 7.25.2.2.4 of 3GPP TR 23.700-98 V1.0.0.

In an embodiment, the endpoint information of the EES is used by the CAS to communicate with the EES to start a target EAS discovery procedure for example as described in clause 8.5 of 3GPP TS 23.558 V17.3.0.

In an embodiment, the CAS is found out via Domain Name System (DNS) query/discovery.

As a first example, if the ACR required is self-detected, the S-EAS requests the EES to discover the targets as described in 3GPP TS 23.558 V17.3.0. When EES determines that no relevant EAS is available for the UE's location it finds out the details of the CAS, e.g. via DNS query/discovery.

As a second example, when EES determines that no relevant EAS is available for the UE's location, it finds out the details of the CAS, e.g. via DNS query/discovery.

As a third example, the AC triggers the UE to perform DNS resolution for the CAS relevant for the AC. The UE may need to establish a new PDU connection to the CAS.

At block 304, the CAS may store the endpoint information of the EES.

At block 306, optionally, the CAS may send a first response to the EES.

FIG. 3b shows a flowchart of a method according to another embodiment of the present disclosure, which may be performed by an apparatus implemented in or at or as a CAS or communicatively coupled to the CAS. As such, the apparatus may provide means or modules for accomplishing various parts of the method 310 as well as means or modules for accomplishing other processes in conjunction with other components. For some parts which have been described in the above embodiments, the description thereof is omitted here for brevity.

At block 312, the CAS may send a first request to a central repository. The first request may be used for retrieving information of an edge enabler server (EES) selected for an edge enabler client (EEC) of a user equipment (UE) or subscribing for the information of the EES selected for the EEC of the UE.

In an embodiment, the CAS is serving or going to serve an AC of the UE.

The central repository may be a repository function which may store and/or provide the information of the EES. In an embodiment, EES may interact with the central repository to store the information of the EES selected for the EEC of the UE.

The central repository may be a separate network function (e.g. a standalone server) or implemented or co-located in a network function such as ECS. For example, an ECS can be enhanced to support discovery of the information of the EES selected for the EEC of the UE. Such enhanced ECSs may have the central repository functionality. In an embodiment, the central repository may be similar to the central repository as described in as described in 3GPP Technical Specification Groups-Service and System Aspects (TSG-SA) Working Group 6 (WG6) Meeting #54, S6-231648, “Common EAS discovery”, 17-26 Apr. 2023.

The first request may be any suitable request such as an existing request or a new request. In an embodiment, the first request may comprise at least one of a selected EES retrieval request or a selected EES subscription request.

The first request may comprise any suitable information which can be used for retrieving information of the EES selected for the EEC of the UE or subscribing for the information of the EES selected for the EEC of the UE.

In an embodiment, the first request may comprise at least one of first information for determining the EES selected for the EEC of the UE, a requestor identifier (ID), or security credentials.

The first information may be any suitable information which can be used to determine the EES selected for the EEC of the UE. In this embodiment, the first request may be a selected EES retrieval request. The requestor identifier may be the identifier of the CAS. The security credentials may result from a successful authorization for the edge computing service. The security credentials may be verified by the central repository.

In an embodiment, the first request may comprise at least one of first information for determining the EES selected for the EEC of the UE, a requestor identifier, security credentials, a notification target address, or an event identifier. In this embodiment, the first request may be an selected EES subscription request. The event identifier may indicate EES selection. It is noted that in addition to the event identifier of EES selection, other information element with the similar/same meanings may also be used. The notification target address may indicate a notification target address where the notification is to be sent.

In an embodiment, the first information may comprise an edge application server (EAS) identifier, a UE identifier, or an application client (AC) identifier. In other embodiment, the first information may comprise any other suitable information for determining the EES selected for the EEC of the UE.

The EAS identifier may identify a particular application for e.g. Video, Game etc. The definition of the EAS identifier may be any suitable forms and the present disclosure has no limit on it. In an embodiment, the EAS identifier may be same or similar as/to the EAS identifier as described in 3GPP TR 23.700-98 V18.1.0, S6-231648 or 3GPP TS 23.558 V18.2.0.

The UE identifier may be an identifier of the UE. The UE ID may uniquely identify a particular UE within a Public Land Mobile Network (PLMN) domain.

UE ID can be a Generic Public Subscription Identifier (GPSI) as defined in 3GPP TS 23.501 V18.0.0.

NOTE 1: For user's privacy reasons, GPSI in the form of Mobile Subscriber Integrated Services Digital Network (ISDN) Number (MSISDN) can be used only after obtaining user's consent.

NOTE 2: To protect user's privacy, if MSISDN cannot be used then AF-specific UE ID which is a GPSI in the form of an External ID may either be acquired through the NEF's Nnef_UEId_Get service operation (see 3GPP TS 23.501 V18.0.0 clause 4.15.10) or other means (e.g. preconfiguration).

UE ID can be an EEL-generated Edge UE ID, as defined in clause 7.2.9 of 3GPP TS 23.558 V18.2.0.

The AC identifier may be an identifier of the AC. If the identifier of the UE is omitted, it implies any AC. For example, the AC ID may identify the client side of a particular application, for e.g. SA6Video viewer, SA6MsgClient etc. For example, all SA6MsgClient clients will share the same AC ID. In case that the UE is running mobile operating system (OS), the AC ID may be a pair of OS ID and OS Application ID. In an embodiment, the AC ID may be same or similar as/to the AC ID as described in 3GPP TR 23.700-98 V18.1.0 or 3GPP TS 23.558 V18.2.0.

The CAS can send the first request to the central repository in various ways and the present disclosure has no limit on it. For example when the CAS is serving or is going to serve an AC, the CAS can send the first request to the central repository. When the CAS decides to initiate ACR via ECS, the CAS can send the first request to the central repository.

At block 314, the CAS may receive a first message from the central repository.

The first message may be any suitable message such as an existing message or a new message.

In an embodiment, the first message may comprise at least one of a selected EES retrieval response or a selected EES notification. For example, if the first request is a selected EES retrieval request, the first message may be a selected EES retrieval response. If the first request is a selected EES subscription request, the first message may be a selected EES notification.

In an embodiment, when the first message is a selected EES retrieval response, the selected EES retrieval response may comprise at least one of an information element indicating that the first request is successful or failed, the information of the EES selected for the EEC of the UE when the first request is successful, or a failure cause when the first request is failed.

In an embodiment, when the first message is a selected EES notification, the selected EES notification may comprise at least one of a subscription identifier, an event identifier, or the information of the EES selected for the EEC of the UE.

The information of the EES selected for the EEC of the UE may comprise any suitable information. In an embodiment, the information of the EES selected for the EEC of the UE may comprise at least one of a UE identifier, a selected EES identifier, selected EES endpoint information, an EAS identifier, or an AC identifier.

In an embodiment, the endpoint information of the EES selected for the EEC of the UE may comprise at least one of Uniform Resource Identifier (URI), Fully Qualified Domain Name (FQDN), or Internet protocol address.

The information of the EES selected for the EEC of the UE may be used by the EAS for various purposes and the present disclosure has no limit on it. In an embodiment, the information of the EES selected for the EEC of the UE may be used by the CAS to at least one of communicate with the selected EES to start a target EAS discovery procedure, trigger a service continuity procedure towards the selected EES, subscribe to receive application context transfer (ACT) status notification, or subscribe to receive application context relocation (ACR) management notification for example as described in 3GPP TR 23.700-98 V18.1.0 or 3GPP TS 23.558 V18.2.0.

FIG. 3c shows a flowchart of a method according to another embodiment of the present disclosure, which may be performed by an apparatus implemented in or at or as a CAS or communicatively coupled to the CAS. As such, the apparatus may provide means or modules for accomplishing various parts of the method 320 as well as means or modules for accomplishing other processes in conjunction with other components. For some parts which have been described in the above embodiments, the description thereof is omitted here for brevity.

At block 322, the CAS may store the information of the EES selected for the EEC of the UE. For example, the CAS may store the information of the EES selected for the EEC of the UE for various purposes as described above.

FIG. 3d shows a flowchart of a method according to another embodiment of the present disclosure, which may be performed by an apparatus implemented in or at or as a CAS or communicatively coupled to the CAS. As such, the apparatus may provide means or modules for accomplishing various parts of the method 330 as well as means or modules for accomplishing other processes in conjunction with other components. For some parts which have been described in the above embodiments, the description thereof is omitted here for brevity.

At block 332, when the first request is a selected EES subscription request message, the CAS may receive a selected EES subscription response from the central repository.

In an embodiment, the selected EES subscription response may comprise at least one of an information element indicating that the first request is successful or failed, a subscription identifier when the first request is successful, or a failure cause when the first request is failed.

FIG. 4a shows a flowchart of a method according to another embodiment of the present disclosure, which may be performed by an apparatus implemented in or at or as an edge enabler server (EES) selected for an edge enabler client (EEC) of a user equipment (UE) or communicatively coupled to the EES. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, the EES may send a first request to a cloud application server (CAS) during a procedure of application context relocation (ACR) or after the EES receiving an edge application server (EAS) information provisioning request. The first request comprises endpoint information of the EES.

At block 404, optionally, the EES may receive a first response from the CAS.

In an embodiment, the endpoint information of the EES may comprise at least one of Uniform Resource Identifier (URI), Fully Qualified Domain Name (FQDN), or Internet protocol address.

In an embodiment, the first request may be a selected EES declaration request.

In an embodiment, the ACR may be between edge application server (EAS) and CAS.

In an embodiment, the ACR may be initiated by an edge enabler client (EEC) using regular EAS discovery.

In an embodiment, the ACR may be executed by EEC via the EES.

In an embodiment, the ACR may be decided by a source EAS.

In an embodiment, the ACR may be executed by the EES.

In an embodiment, the endpoint information of the EES may be used by the CAS to communicate with the EES to start a target EAS discovery procedure.

FIG. 4b shows a flowchart of a method according to another embodiment of the present disclosure, which may be performed by an apparatus implemented in or at or as an EES or communicatively coupled to the EES. As such, the apparatus may provide means or modules for accomplishing various parts of the method 410 as well as means or modules for accomplishing other processes in conjunction with other components. For some parts which have been described in the above embodiments, the description thereof is omitted here for brevity.

At block 412, the EES may receive a first ACR request from an edge enabler client (EEC). The first ACR request comprises information indicating that EES informs the CAS with the endpoint information of the EES.

Optionally, the EES may send a first ACR response to the EEC.

As an example, the EEC performs ACR launching procedure (as described in clause 8.8.3.4 of 3GPP TS 23.558 V17.3.0) to the EES with the ACR action indicating ACR initiation and the corresponding ACR initiation data (along with the details of the CAS and without the need to notify the EAS, and with the need to inform the CAS with the endpoint information of the EES).

At block 414, the EES may send a first request to the CAS during a procedure of ACR.

The first request comprises endpoint information of the EES.

FIG. 4c shows a flowchart of a method according to another embodiment of the present disclosure, which may be performed by an apparatus implemented in or at or as an EES or communicatively coupled to the EES. As such, the apparatus may provide means or modules for accomplishing various parts of the method 420 as well as means or modules for accomplishing other processes in conjunction with other components. For some parts which have been described in the above embodiments, the description thereof is omitted here for brevity.

At block 422, the EES may receive a selected CAS declaration message from a source EAS. The selected CAS declaration message informs the EES a determined CAS to use.

At block 424, the EES may send a first request to the CAS during a procedure of ACR. The first request comprises endpoint information of the EES.

FIG. 4d shows a flowchart of a method according to another embodiment of the present disclosure, which may be performed by an apparatus implemented in or at or as an EES or communicatively coupled to the EES. As such, the apparatus may provide means or modules for accomplishing various parts of the method 430 as well as means or modules for accomplishing other processes in conjunction with other components. For some parts which have been described in the above embodiments, the description thereof is omitted here for brevity.

At block 432, the EES may determine that no relevant EAS is available for a location of a user equipment.

At block 434, the EES may determine the CAS.

For example, the EES determines the targets via the Discover T-EAS procedure in clause 8.8.3.2 of 3GPP TS 23.558 V17.3.0. When EES determines that no relevant EAS is available for the UE's location, it finds out the details of the CAS, e.g. via DNS query/discovery.

At block 436, the EES may send a first request to the CAS during a procedure of ACR or after the EES receiving an EAS information provisioning request. The first request comprises endpoint information of the EES.

In an embodiment, the CAS is found out via Domain Name System (DNS) query/discovery.

FIG. 4e shows a flowchart of a method according to another embodiment of the present disclosure, which may be performed by an apparatus implemented in or at or as an EES or communicatively coupled to the EES. As such, the apparatus may provide means or modules for accomplishing various parts of the method 440 as well as means or modules for accomplishing other processes in conjunction with other components. For some parts which have been described in the above embodiments, the description thereof is omitted here for brevity.

At block 442, the EES may send a second request to a central repository. The second request may comprise the information of the EES which is selected for an edge enabler client (EEC) of a user equipment (UE).

At block 444, the EES may receive a second response from the central repository.

The EES may send the second request to the central repository in various ways. For example, when the EES knows that it is selected for the EEC of the UE, the EES may send the second request to the central repository for example immediately or at any suitable time point.

In an embodiment, the second request may be sent to the central repository during a procedure of application context relocation (ACR) or after the EES receiving an edge application server (EAS) information provisioning request for example as described in 3GPP TR 23.700-98 V18.1.0 or 3GPP TS 23.558 V18.2.0.

In an embodiment, the ACR may be initiated by an edge enabler client (EEC) using regular EAS discovery, and/or the ACR is executed by EEC via the EES, and/or the ACR is decided by a source EAS, and/or the ACR is executed by the EES.

The second request may be any suitable request such as an existing request or a new request. The second response may be any suitable response such as an existing response or a new response. In an embodiment, the second request may be a selected EES declaration request and/or the second response is a selected EES declaration response.

In an embodiment, the second request may further comprise security credentials. Security credentials may result from a successful authorization for the edge computing service. The security credentials may be verified by the central repository.

In an embodiment, the second response may comprise at least one of an information element indicating that the second request is successful or failed, or a failure cause when the second request is failed.

In an embodiment, the information of the EES selected for the EEC of the UE may comprise at least one of a UE identifier, a selected EES identifier, selected EES endpoint information, an edge application server (EAS) identifier, or an AC identifier.

In an embodiment, the endpoint information of the EES selected for the EEC of the UE may comprise at least one of Uniform Resource Identifier (URI), Fully Qualified Domain Name (FQDN), or Internet protocol address.

In an embodiment, the information of the EES selected for the EEC of the UE may be used by a CAS to at least one of communicate with the selected EES to start a target EAS discovery procedure, trigger a service continuity procedure towards the selected EES, subscribe to receive application context transfer (ACT) status notification, or subscribe to receive application context relocation (ACR) management notification.

In an embodiment, the CAS is serving or going to serve an AC of the UE.

In an embodiment, the central repository may be a standalone server or implemented or co-located in an edge configuration server.

FIG. 4f shows a flowchart of a method according to another embodiment of the present disclosure, which may be performed by an apparatus implemented in or at or as a central repository or communicatively coupled to the central repository. As such, the apparatus may provide means or modules for accomplishing various parts of the method 450 as well as means or modules for accomplishing other processes in conjunction with other components. For some parts which have been described in the above embodiments, the description thereof is omitted here for brevity.

At block 452, the central repository may receive a first request from a cloud application server (CAS). The first request may be used for retrieving information of an edge enabler server (EES) selected for an edge enabler client (EEC) of a user equipment (UE) or subscribing for the information of the EES selected for the EEC of the UE.

At block 454, the central repository may send a first message to the CAS.

In an embodiment, the central repository may be a standalone server or implemented or co-located in an edge configuration server.

In an embodiment, the first request may comprise at least one of first information for determining the EES selected for the EEC of the UE, a requestor identifier, or security credentials.

In an embodiment, the first request may comprise at least one of first information for determining the EES selected for the EEC of the UE, a requestor identifier, security credentials, a notification target address, or an event identifier.

In an embodiment, the first information may comprise at least one of an edge application server (EAS) identifier, a UE identifier, or an application client (AC) identifier.

In an embodiment, the first request may comprise at least one of a selected EES retrieval request, or a selected EES subscription request.

In an embodiment, the first message may comprise at least one of a selected EES retrieval response, or a selected EES notification.

In an embodiment, when the first message is a selected EES retrieval response, the selected EES retrieval response may comprise at least one of an information element indicating that the first request is successful or failed, the information of the EES selected for the EEC of the UE when the first request is successful, or a failure cause when the first request is failed.

In an embodiment, when the first message is a selected EES notification, the selected EES notification may comprise at least one of a subscription identifier, an event identifier, or the information of the EES selected for the EEC of the UE.

In an embodiment, the CAS is serving or going to serve an AC of the UE.

In an embodiment, the information of the EES selected for the EEC of the UE may comprise at least one of a UE identifier, a selected EES identifier, selected EES endpoint information, an EAS identifier, or an AC identifier.

In an embodiment, the endpoint information of the EES selected for the EEC of the UE may comprise at least one of Uniform Resource Identifier (URI), Fully Qualified Domain Name (FQDN), or Internet protocol address.

In an embodiment, the information of the EES selected for the EEC of the UE may be used by the CAS to at least one of communicate with the selected EES to start a target EAS discovery procedure, trigger a service continuity procedure towards the selected EES, subscribe to receive application context transfer (ACT) status notification, or subscribe to receive application context relocation (ACR) management notification.

FIG. 4g shows a flowchart of a method according to another embodiment of the present disclosure, which may be performed by an apparatus implemented in or at or as a central repository or communicatively coupled to the central repository. As such, the apparatus may provide means or modules for accomplishing various parts of the method 460 as well as means or modules for accomplishing other processes in conjunction with other components. For some parts which have been described in the above embodiments, the description thereof is omitted here for brevity.

At block 462, when the first request is a selected EES subscription request message, the central repository may send a selected EES subscription response to the CAS.

In an embodiment, the selected EES subscription response may comprise at least one of an information element indicating that the first request is successful or failed, a subscription identifier when the first request is successful, or a failure cause when the first request is failed.

FIG. 4h shows a flowchart of a method according to another embodiment of the present disclosure, which may be performed by an apparatus implemented in or at or as a central repository or communicatively coupled to the central repository. As such, the apparatus may provide means or modules for accomplishing various parts of the method 470 as well as means or modules for accomplishing other processes in conjunction with other components. For some parts which have been described in the above embodiments, the description thereof is omitted here for brevity.

At block 472, when the first request is a selected EES retrieval request, the central repository may check whether the CAS is authorized to perform a retrieving operation.

In an embodiment, when the CAS is authorized to perform the retrieving operation, the central repository may further process the first request, e.g. retrieving the information of the EES selected for the EEC of the UE. The first message may comprise a retrieving result.

In an embodiment, if the CAS is not authorized to perform the retrieving operation, the central repository may send a failure response indicating that the first request has failed to the CAS for example due to authorization failure.

FIG. 4i shows a flowchart of a method according to another embodiment of the present disclosure, which may be performed by an apparatus implemented in or at or as a central repository or communicatively coupled to the central repository. As such, the apparatus may provide means or modules for accomplishing various parts of the method 480 as well as means or modules for accomplishing other processes in conjunction with other components. For some parts which have been described in the above embodiments, the description thereof is omitted here for brevity.

At block 482, when the first request is a selected EES subscription request, the central repository may authorize the first request.

At block 484, the central repository may store event subscription when the first request is authorized.

In an embodiment, when the CAS is authorized to perform the subscription operation, the central repository may store event subscription and send a notification comprising the information of the EES selected for the EEC of the UE to the CAS when the information of the EES selected for the EEC of the UE is available in the central repository.

In an embodiment, if the CAS is not authorized to perform the subscription operation, the central repository may send a failure response indicating that the first request has failed to the CAS. The first request may comprise a cause indicating authorization failure.

FIG. 4j shows a flowchart of a method according to another embodiment of the present disclosure, which may be performed by an apparatus implemented in or at or as a central repository or communicatively coupled to the central repository. As such, the apparatus may provide means or modules for accomplishing various parts of the method 490 as well as means or modules for accomplishing other processes in conjunction with other components. For some parts which have been described in the above embodiments, the description thereof is omitted here for brevity.

At block 492, the central repository may receive a second request from the EES selected for the EEC of the UE. The second request may comprise the information of the EES selected for the EEC of the UE.

The central repository may receive the second request from the EES selected for the EEC of the UE in various ways. For example, when the EES knows it is selected for the EEC of the UE, it may send the second request to the central repository for example immediately or at any suitable time point and then the central repository may receive the second request.

In an embodiment, the central repository may receive the second request during a procedure of ACR or after the EES receiving an EAS information provisioning request. For example, during a procedure of ACR or after the EES receiving an EAS information provisioning request, the EES may send the second request to the central repository and then the central repository may receive the second request.

At block 494, the central repository may store the information of the EES selected for the EEC of the UE. For example, the central repository may store this information locally or in another storage function.

At block 496, the central repository may send a second response to the EES selected for the EEC of the UE.

The second response may comprise any suitable information such as a processing result of the second request. In an embodiment, the second response may comprise at least one of an information element indicating that the second request is successful or failed, or a failure cause when the second request is failed.

In an embodiment, the second request may be a selected EES declaration request and/or the second response may be a selected EES declaration response.

In an embodiment, the second request may further comprise security credentials.

FIG. 4k shows a flowchart of a method according to another embodiment of the present disclosure, which may be performed by an apparatus implemented in or at or as a central repository or communicatively coupled to the central repository. As such, the apparatus may provide means or modules for accomplishing various parts of the method 4900 as well as means or modules for accomplishing other processes in conjunction with other components. For some parts which have been described in the above embodiments, the description thereof is omitted here for brevity.

At block 4902, the central repository may check whether the EES selected for the EEC of the UE is authorized to perform a storing operation. In other embodiment, the central repository may authorize the second request.

In an embodiment, when the EES selected for the EEC of the UE is authorized to perform the storing operation or the authorization of the second request is successful, the central repository may store the information of the EES selected for the EEC of the UE.

In an embodiment, when the EES selected for the EEC of the UE is not authorized to perform the storing operation or the authorization of the second request is failed, the central repository may send a failure response indicating that the second request has failed to the EES. the second request may comprise a cause indicating authorization failure.

In an embodiment, the second response may comprise at least one of an information element indicating that the second request is successful or failed, or a failure cause when the second request is failed.

FIG. 5a shows a flowchart of a method according to another embodiment of the present disclosure, which may be performed by an apparatus implemented in or at or as an EEC or communicatively coupled to the EEC. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 502, the EEC may send a first application context relocation (ACR) request to an edge enabler server (EES) selected for an edge enabler client (EEC) of a user equipment (UE) during a procedure of ACR. The first ACR request comprises information indicating that EES informs a cloud application server (CAS) with endpoint information of the EES.

In an embodiment, the endpoint information of the EES comprises at least one of Uniform Resource Identifier (URI), Fully Qualified Domain Name (FQDN), or Internet protocol address.

In an embodiment, the ACR is between edge application server (EAS) and CAS.

In an embodiment, the ACR is initiated by an edge enabler client (EEC) using regular EAS discovery.

In an embodiment, the ACR is executed by EEC via the EES.

In an embodiment, the endpoint information of the EES is used by the CAS to communicate with the EES to start a target EAS discovery procedure.

In an embodiment, the CAS is found out via Domain Name System (DNS) query/discovery.

FIG. 5b shows a flowchart of a method according to another embodiment of the present disclosure, which may be performed by an apparatus implemented in or at or as an EEC or communicatively coupled to the EEC. As such, the apparatus may provide means or modules for accomplishing various parts of the method 510 as well as means or modules for accomplishing other processes in conjunction with other components. For some parts which have been described in the above embodiments, the description thereof is omitted here for brevity.

At block 512, the EEC may receive a second ACR request from an application client (AC). The second ACR request comprises information indicating that an included target EAS is CAS. Optionally, the EEC may send a second ACR response to the AC.

At block 514, the EEC may send a first application context relocation (ACR) request to an edge enabler server (EES) selected for an edge enabler client (EEC) of a user equipment (UE) during a procedure of ACR. The first ACR request comprises information indicating that EES informs a cloud application server (CAS) with endpoint information of the EES. Optionally, the EEC may receive a first ACR response from the EES.

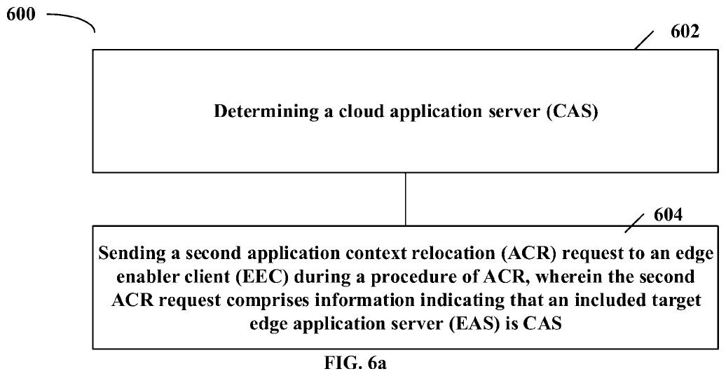

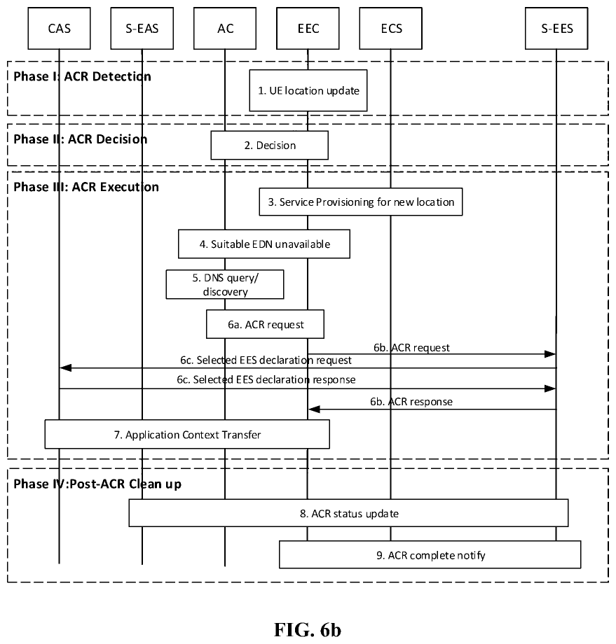

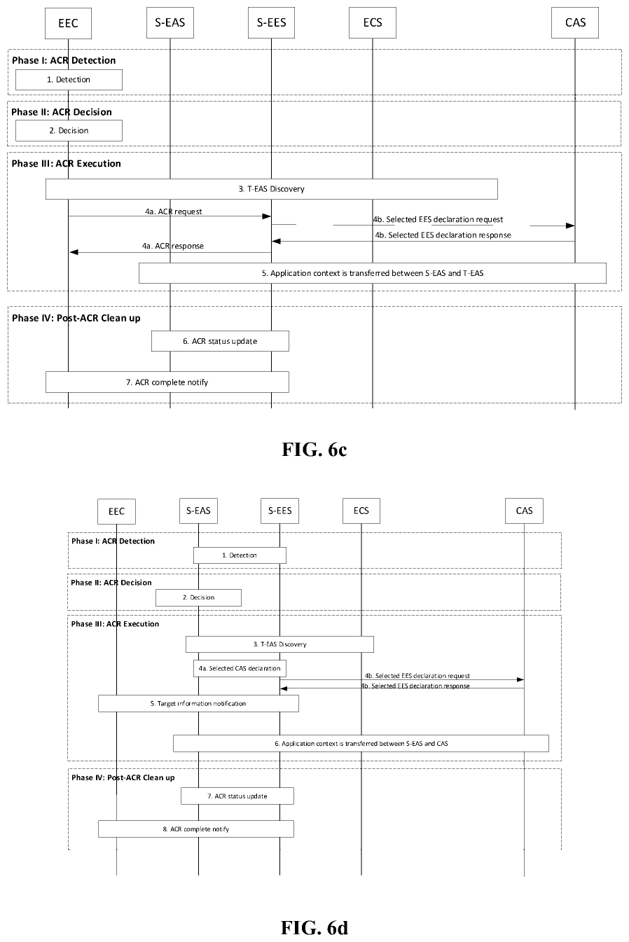

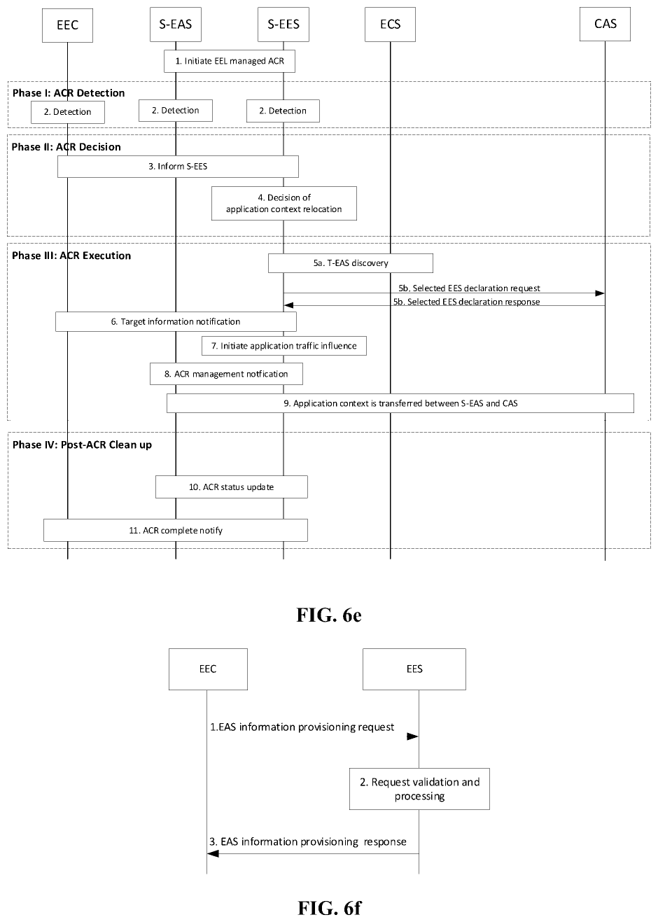

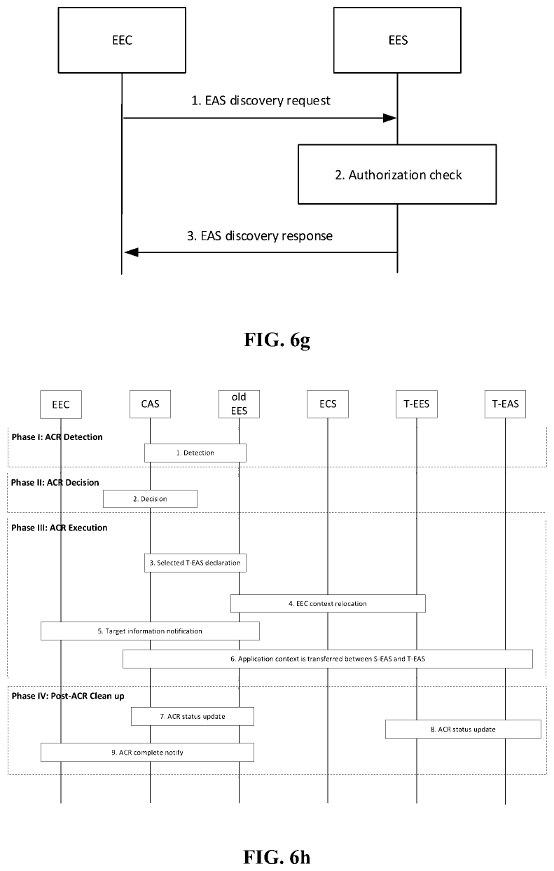

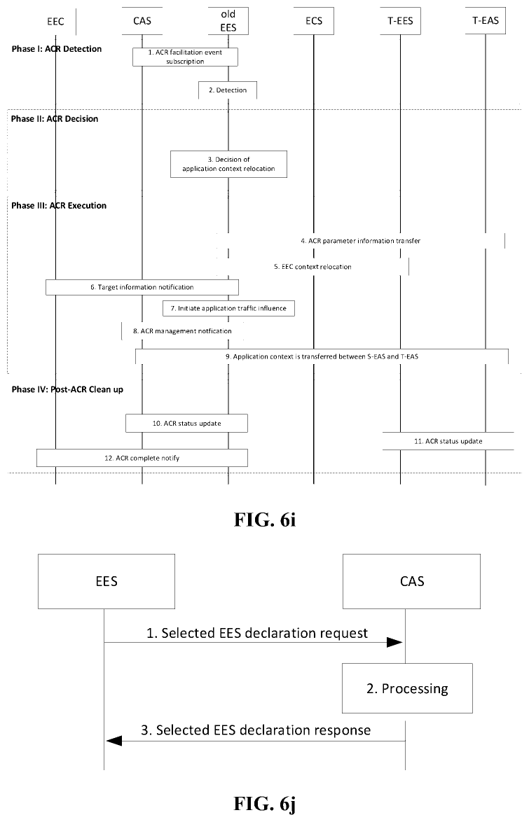

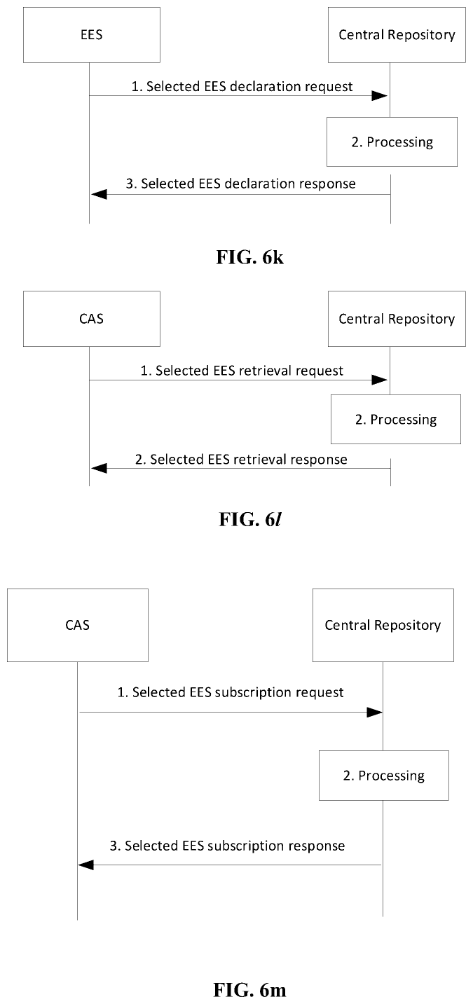

FIG. 6a shows a flowchart of a method according to another embodiment of the present disclosure, which may be performed by an apparatus implemented in or at or as an AC or communicatively coupled to the AC. As such, the apparatus may provide means or modules for accomplishing various parts of the method 600 as well as means or modules for accomplishing other processes in conjunction with other components. For some parts which have been described in the above embodiments, the description thereof is omitted here for brevity.

At block 602, the AC may determine a cloud application server (CAS).

As a first example, if the change in the UE's location triggers a need to change the S-EAS but the EEC is not provided with a T-EAS, the EEC informs the AC of the unavailability of a suitable EDN for the new location of the UE. The AC triggers the UE to perform DNS resolution for the CAS relevant for the AC. The UE may need to establish a new PDU connection to the CAS.

As a second example, the EEC performs Service Provisioning for all active applications that require ACR. Since the location of the UE has changed, this procedure results in unavailability of T-EESs that are relevant to the supplied applications and the new location of the UE, as per the assumption of this scenario. Service provisioning or discovery of relevant T-EAS may not result in EES configuration or T-EAS is not discovered respectively. The AC triggers the UE to perform DNS resolution for the cloud application server relevant for the AC. The UE may need to establish a new PDU connection to the CAS.

At block 604, the AC may send a second application context relocation (ACR) request to an edge enabler client (EEC) during a procedure of ACR. The second ACR request comprises information indicating that an included target edge application server (EAS) is CAS.

In an embodiment, the CAS is found out via Domain Name System (DNS) query/discovery.

In an embodiment, the ACR is initiated by an edge enabler client (EEC) using regular EAS discovery.

In an embodiment, the ACR is executed by EEC via the EES.

In an embodiment, the ACR is between edge application server (EAS) and CAS.

Some embodiments of present disclosure describe a way for CAS to know the EES.

On the UE side, once AC informs the EEC to start ACR with CAS endpoint as T-EAS information, the AC shall in addition indicate that the T-EAS is a CAS. Then the EEC needs to include “inform CAS” indication in the ACR request for EEC launched ACR procedure. EES further informs CAS with EES contact information. CAS knows which EES is currently serving the application session as enabling layer so the CAS stores the received EES information.

In the S-EAS executed ACR scenario, the EES needs to informs CAS upon receipt of the “selected CAS declaration” from the S-EAS.

In the EES executed ACR scenario, the EES needs to inform CAS after CAS determination.

Noting that CAS should provide the service as service producer.

In an embodiment, clause 7.25.2.2.1 of 3GPP TR 23.700-98 V1.0.0 may be amended as following.

The scenario handles ACR as a result of the UE moving to, or the UE expecting to move to, a new location which is outside the service area of the serving EAS. It further relies on the EEC being triggered as a result of the UE's movement.

This scenario is based on Service Provisioning (as specified in TS 23.558) and DNS procedures to discover the CAS that shall serve the AC as a result of the UE's new location, and that shall receive the Application Context from the serving EASs. The scenario below describes the relocation of a single application context to a CAS. However, it should be repeated for each active AC in the UE for which EAS or EDN is not available on that UE location.

FIG. 6b shows a flowchart of ACR initiated by the EEC and AC according to another embodiment of the present disclosure.

The pre-conditions:
1. The AC in the UE already has a connection to a corresponding S-EAS;
2. The preconditions for the Service provisioning-Request/Response model as specified in 3GPP TS 23.558 V17.3.0 with regards to the EEC are fulfilled; and
3. The EEC is triggered when it obtains the UE's new location or is triggered by another entity such as an ECS notification.

### Phase I: ACR Detection

Step 1. The EEC detects the UE location update as a result of a UE mobility event and is provided with the UE's new location as described in 3GPP TS 23.558 V17.3.0. The EEC can also detect an expected or predicted UE location in the future as described in 3GPP TS 23.558 V17.3.0.

NOTE 1: If the EEC is triggered by an external entity such as by a notification from the ECS, unavailability of new EESs (to be used as T-EESs) is provided by that notification and step 3 below is skipped.

### Phase II: ACR Decision

Step 2. Either the AC or the EEC makes the decision to perform the ACR.

NOTE 2: Which applications require ACR can be decided based on the application profile, e.g. requirement of service continuity of the application.

### Phase III: ACR Execution

Step 3. The EEC performs Service Provisioning (as specified in TS 23.558) for all active applications that require ACR. Since the location of the UE has changed, this procedure results in unavailability of T-EESs that are relevant to the supplied applications and the new location of the UE. If the service provisioning is done without supplying the application information but EES information is provisioned, the EEC attempts discovering relevant T-EAS with the EES provisioned in the service provisioning response, if any. Service provisioning or discovery of relevant T-EAS may not result in EES configuration or T-EAS is not discovered respectively.

If the change in UE's location does not trigger a need to change the serving EAS, the subsequent steps will not take place. The EEC remains connected to the serving EESs and the ACs remain connected to their corresponding serving EASs.

Step 4. If the change in the UE's location triggers a need to change the S-EAS but the EEC is not provided with a T-EAS, the EEC informs the AC of the unavailability of a suitable EDN for the new location of the UE.

Step 5. The AC triggers the UE to perform DNS resolution for the CAS relevant for the AC. The UE may need to establish a new PDU connection to the CAS.

Step 6a. The AC sends ACR request to the EEC with an indication that the included T-EAS is CAS, and the EEC responds ACR response to the AC.

Step 6b. The EEC performs ACR launching procedure (as described in 3GPP TS 23.558 V17.3.0) to the S-EES with the ACR action indicating ACR initiation and the corresponding ACR initiation data (along with the details of the CAS and without the need to notify the EAS, and with the need to inform the CAS). The S-EES may apply the AF traffic influence with the N6 routing information of the CAS in the 3GPP Core Network (if applicable), as described in 3GPP TS 23.558 V17.3.0.

Step 6c. During execution of step 6b, the S-EES informs the CAS with the S-EES endpoint information by selected EES declaration request. The CAS stores the S-EES endpoint information and responds selected EES declaration response.

Step 7. The AC is triggered by the EEC to start ACT. The AC decides to initiate the transfer of application context from the S-EAS to the CAS.

After the ACT is completed, the AC remains connected to the CAS and disconnects from the S-EAS; the EEC is informed of the completion of the ACT.

The S-EAS or CAS can further decide to terminate the ACR, and the CAS can discard the application context (e.g. based on monitoring the location of the UE). It is up to the implementation of the S-EAS and CAS whether and how to make such a decision.

### Phase IV: Post-ACR Clean Up

Step 8. The S-EAS sends the ACR status update message to the S-EES as specified in TS 23.558.

Step 9. If the status in step 8 indicates a successful ACT, the S-EES sends the ACR information notification (ACR complete) message to the EEC to confirm that the ACR has completed as specified in 3GPP TS 23.558 V17.3.0.

The CAS can perform the required CN capability exposure subscriptions upon receiving the application context.

Updated 3GPP TS 23.558 V17.3.0 for other scenarios is FFS.

In an embodiment, clause 7.25.2.2.2 of 3GPP TR 23.700-98 V1.0.0 may be amended as following.

In this scenario, the EEC is triggered as a result of the UE's movement as described in 8.8.1.1 of 3GPP TS 23.558 V17.3.0.

FIG. 6c shows a flowchart of the EEC executing ACR via the S-EES according to another embodiment of the present disclosure.

### Pre-Condition:

1. The AC at the UE already has a connection to the S-EAS; and
2. The EEC is able to communicate with the S-EES.

### Phase I: ACR Detection

Step 1. The EEC detects that ACR may be required as described in clause 8.8.1.1 of TS 23.558. The EEC may detect that ACR may be required for an expected or predicted UE location in the future as described in clause 8.8.1.1 of 3GPP TS 23.558 V17.3.0.

### Phase II: ACR Decision

Step 2. The EEC decides to proceed required procedures for triggering ACR.

### Phase III: ACR Execution

Step 3. The EEC performs Service Provisioning (as specified in TS 3GPP TS 23.558 V17.3.0) for all active applications that require ACR. Since the location of the UE has changed, this procedure results in unavailability of T-EESs that are relevant to the supplied applications and the new location of the UE, as per the assumption of this scenario. Service provisioning or discovery of relevant T-EAS may not result in EES configuration or T-EAS is not discovered respectively. The AC triggers the UE to perform DNS resolution for the cloud application server relevant for the AC. The UE may need to establish a new PDU connection to the CAS.

NOTE 1: Several EEC registrations with different EESs may result from T-EAS discovery process during a single ACR operation.

If the service provisioning is done without supplying the application information, the EEC attempts discovering relevant T-EAS with the EES provisioned in the service provisioning response is FFS

Step 4a. The EEC performs ACR launching procedure (as described in clause 8.8.3.4 of 3GPP TS 23.558 V17.3.0) to the S-EES with the ACR action indicating ACR initiation and the corresponding ACR initiation data (along with the details of the CAS and with the need to notify the EAS, and with the need to inform the CAS). The S-EES authorizes the request from the EEC. The S-EES decides to execute ACR based on the information received from the EEC and/or EAS profile. The S-EES may apply the AF traffic influence with the N6 routing information of the CAS in the 3GPP Core Network (if applicable) and sends the ACR management notification for the “ACT start” event to the S-EAS, as described in clause 8.6.3 of 3GPP TS 23.558 V17.3.0, to initiate ACT between the S-EAS and the CAS. If the EEC has not subscribed to receive ACR information notifications for ACR complete events from the S-EES, the EEC subscribes for the notifications as described in clause 8.8.3.5.2 of 3GPP TS 23.558 V17.3.0.

Step 4b. During execution of step 6a, the S-EES informs the CAS with the S-EES endpoint information by selected EES declaration request. The CAS stores the S-EES endpoint information and responds selected EES declaration response.

Step 5. The S-EAS transfers the application context to the CAS at implementation specific time. This process is out of scope of the present specification.

NOTE 2: The S-EAS or CAS can further decide to terminate the ACR, and the CAS can discard the application context based on information received from EEL and/or other methods (e.g. monitoring the location of the UE). It is up to the implementation of the S-EAS and CAS whether and how to make such a decision.

### Phase IV: Post-ACR Clean Up

Step 6. The S-EAS sends the ACR status update message to the S-EES as specified in clause 8.8.3.8 of 3GPP TS 23.558 V17.3.0.

Step 7. If the status in step 7 indicates a successful ACT (Application Context Transfer), the S-EES sends the ACR information notification (ACR complete) message to the EEC to confirm that the ACR has completed as specified in clause 8.8.3.5.3 of 3GPP TS 23.558 V17.3.0.

CAS performing the required CN capability exposure subscriptions upon receiving the application context is FFS.

In an embodiment, clause 7.25.2.2.3 of 3GPP TR 23.700-98 V1.0.0 may be amended as following.

In this scenario, the S-EAS may detect the need of ACR locally or is notified by the S-EES via ACR management notifications for “ACR monitoring” events. The S-EAS make the decision about whether to perform the ACR, and starts the ACR at a proper time.

FIG. 6d shows a flowchart of S-EAS decided ACR according to another embodiment of the present disclosure.

### Pre-Conditions:

1. The S-EAS may depend on the receipt of certain User plane path management events from the S-EES, e.g. “user plane path change” events or “ACR monitoring” events, to detect the need for an ACR. For the following procedure it is assumed that the S-EAS has subscribed to continuously receive the respective events from the S-EES; and
2. The EEC has subscribed to receive ACR information notifications for target information notification events and ACR complete events from the S-EES, as described in clause 8.8.3.5.2 of 3GPP TS 23.558 V17.3.0.

S-EAS decided ACR is outlined with four main phases: detection, decision, execution and clean up.

### Phase I: ACR Detection

Step 1. The S-EAS either receives ACR management notifications from source Edge Enabler Sever indicating that ACR may be required (“ACR monitoring” event), or self detects the need for ACR (e.g. upon receipt of a “user plane path change” event). If the ACR management notification indicates “ACR monitoring” event, then the notification will also contain the CAS information (see clause 8.6.3.2.3 of 3GPP TS 23.558 V17.3.0). The S-EAS may detect that ACR may be required for an expected or predicted UE location in the future as described in clause 8.8.1.1 of 3GPP TS 23.558 V17.3.0.

NOTE 1: How the S-EAS self-detects the local need for ACR is outside the scope of this specification.

### Phase II: ACR Decision

Step 2. The S-EAS makes the decision to perform the ACR

NOTE 2: How the S-EAS determines when to start the ACR is outside the scope of this specification.

### Phase III: ACR Execution

Step 3. If the ACR required is self-detected, the S-EAS requests the S-EES to discover the targets as described in 3GPP TS 23.558 V17.3.0. When S-EES determines that no relevant EAS is available for the UE's location it finds out the details of the CAS, e.g. via DNS query/discovery, and provides the details of the CAS to the S-EAS. After S-EAS determines to use CAS, the S-EAS may apply the AF traffic influence with the N6 routing information of the CAS in the 3GPP Core Network (if applicable).

NOTE: EAS endpoint in discovery could be a FQDN of CAS, identical with the FQDN used in DNS query.

Step 4a. The S-EAS sends selected CAS declaration message to S-EES, to inform S-EES the determined CAS to use as described in clause 8.8.3.7 of 3GPP TS 23.558 V17.3.0.

Step 4b. The S-EES informs the CAS with the S-EES endpoint information by selected EES declaration request. The CAS stores the S-EES endpoint information and responds selected EES declaration response.

Step 5. Based on the CAS selection information received from the S-EAS, the S-EES sends the target information notification to the EEC as described in clause 8.8.3.5.3 of 3GPP TS 23.558 V17.3.0.

Step 6. The S-EAS transfers the application context to the CAS selected in step 3. This process is out of scope of the present specification.

NOTE 3: The S-EAS or CAS can further decide to terminate the ACR, and the CAS can discard the application context based on information received from EEL and/or other methods (e.g. monitoring the location of the UE). It is up to the implementation of the S-EAS and CAS whether and how to make such a decision.

### Phase IV: Post-ACR Clean Up

Step 7. The S-EAS sends the ACR status update message to the S-EES as specified in clause 8.8.3.8 of 3GPP TS 23.558 V17.3.0.

Step 8. If the status in step 8 indicates a successful ACT, the S-EES sends the ACR information notification (ACR complete) message to the EEC to confirm that the ACR has completed as specified in clause 8.8.3.5.3 of 3GPP TS 23.558 V17.3.0.

CAS performing the required CN capability exposure subscriptions upon receiving the application context is FFS.

In an embodiment, clause 7.25.2.2.4 of 3GPP TR 23.700-98 V1.0.0 may be amended as following.

FIG. 6e shows a flowchart of S-EES detecting, deciding and executing ACR from the S-EAS to the CAS according to another embodiment of the present disclosure.

This may include EELManagedACR by S-EES when initiated by S-EAS as per clause 8.8.3.6 of 3GPP TS 23.558 V17.3.0.

### Pre-Condition:

1. The AC at the UE already has a connection to the S-EAS;
2. The EEC is able to communicate with the S-EES;
3. The EEC has subscribed to receive ACR information notifications for target information notification events and ACR complete events from the S-EES, as described in clause 8.8.3.5.2 of 3GPP TS 23.558 V17.3.0;
4. The S-EAS optionally subscribed to receive ACR management notifications for “ACR facilitation” events to the S-EES, in order to enable detection at S-EAS.
5. In case of EELManagedACR, the CAS has subscribed to receive ACT status notifications as described in clause 8.8.3.6.2.3 of 3GPP TS 23.558 V17.3.0.

Step 1. The S-EAS may initiate EELManagedACR with S-EES as specified in clause 8.8.3.6 of 3GPP TS 23.558 V17.3.0. In this step, the S-EAS and S-EES negotiate an address of the Application Context storage to S-EES. The S-EAS puts the Application Context at this address which can be further accessed by the S-EES when the ACT is required.

In this case, the S-EES executes steps 2 (i.e., S-EES detection), 4, 5, 6, 7, 8, 9 and 11. Rest of steps are skipped.

### Phase I: ACR Detection

Step 2. Detection entities (S-EAS, S-EES, EEC) detect that ACR may be required as described in clause 8.8.1.1 of 3GPP TS 23.558 V17.3.0. The detection by the S-EES may be triggered by the User Plane path change notification received from the 3GPP Core Network due to S-EAS request for “ACR facilitation” event (see clause 8.6.3 of 3GPP TS 23.558 V17.3.0) or due to step 1.

The detection entity may detect that ACR may be required for an expected or predicted UE location in the future as described in clause 8.8.1.1 of 3GPP TS 23.558 V17.3.0.

### Phase II: ACR Decision

Step 3. The detection entity performs ACR launching procedure (as described in clause 8.8.3.4 of 3GPP TS 23.558 V17.3.0) with the ACR action indicating ACR determination and the corresponding ACR determination data.

Step 4. The S-EES authorizes the message if received. The S-EES decides to execute ACR based on the information received or local detection, and the information of EEC context or EAS profile, and then proceed the below steps.

### Phase III: ACR Execution

Step 5a. The S-EES determines the targets via the Discover T-EAS procedure in clause 8.8.3.2 of 3GPP TS 23.558 V17.3.0. When S-EES determines that no relevant EAS is available for the UE's location, it finds out the details of the CAS, e.g. via DNS query/discovery.

Step 5b. The S-EES informs the CAS with the S-EES endpoint information by selected EES declaration request. The CAS stores the S-EES endpoint information and responds selected EES declaration response.

Step 6. The S-EES sends the target information notification to the EEC as described in clause 8.8.3.5.3 of 3GPP TS 23.558 V17.3.0.

Step 7. The S-EES may apply the AF traffic influence with the N6 routing information of the CAS in the 3GPP Core Network (if applicable).

Step 8. The S-EES sends the ACR management notification (e.g. as notification for

“ACR facilitation” event or “ACT start” event as described in clause 8.6.3 of 3GPP TS 23.558 V17.3.0 or due to step 1) to the S-EAS to initiate ACT between the S-EAS and the CAS.

Step 9. The Application Context is transferred from S-EAS to the CAS at implementation specific time. In the case of EELManagedACR, the S-EES accesses the Application Context from the address as per step 1 and the S-EES either engage in the ACT from S-EAS to the CAS (obtained as per step 5) in a secure way or S-EES shares the storage location of the Application Context with the CAS. Further the CAS accesses the Application Context. The S-EAS may also perform the ACT directly with CAS, the specification of such process is out of scope of the present document.

NOTE 1: The Application Context is encrypted and protected by the application layer. The S-EES engages in the packet level transport of the Application Context and has no visibility to the content of the Application Context.

NOTE 2: The S-EAS or CAS can further decide to terminate the ACR, and the CAS can discard the application context based on information received from EEL and/or other methods (e.g. monitoring the location of the UE). It is up to the implementation of the S-EAS and CAS whether and how to make such a decision.

### Phase IV: Post-ACR Clean Up

Step 10. The S-EAS sends the ACT status update message to the S-EES as specified in clause 8.8.3.8 of 3GPP TS 23.558 V17.3.0.

Step 11. If the status in step 10 indicates a successful ACT, the S-EES sends the ACR information notification (ACR complete) message to the EEC to confirm that the ACR has completed as specified in clause 8.8.3.5.3 of 3GPP TS 23.558 V17.3.0.

NOTE 3: The Application Client mechanism to support switchover of the application traffic to CAS is out of scope of the specification.

In an embodiment, clause 7.25.2.2.5 of 3GPP TR 23.700-98 V1.0.0 may be amended as following.

In this scenario, the CAS detects the need for ACR and makes the decision about whether to perform the ACR and starts the ACR at a proper time.

When ACR happens between EAS and CAS, the S-EAS can be the CAS. During the ACR execution phase, the CAS uses the previously stored S-EES information to start the T-EAS discovery procedure and the remaining steps are similar to the “S-EAS decided ACR scenario” as specified in TS 23.558 clause 8.8.2.4, where the CAS acts like the S-EAS.

How CAS detects ACR is FFS.

Whether the UE Identifier need to be shared with the CAS and how it is shared is FFS.

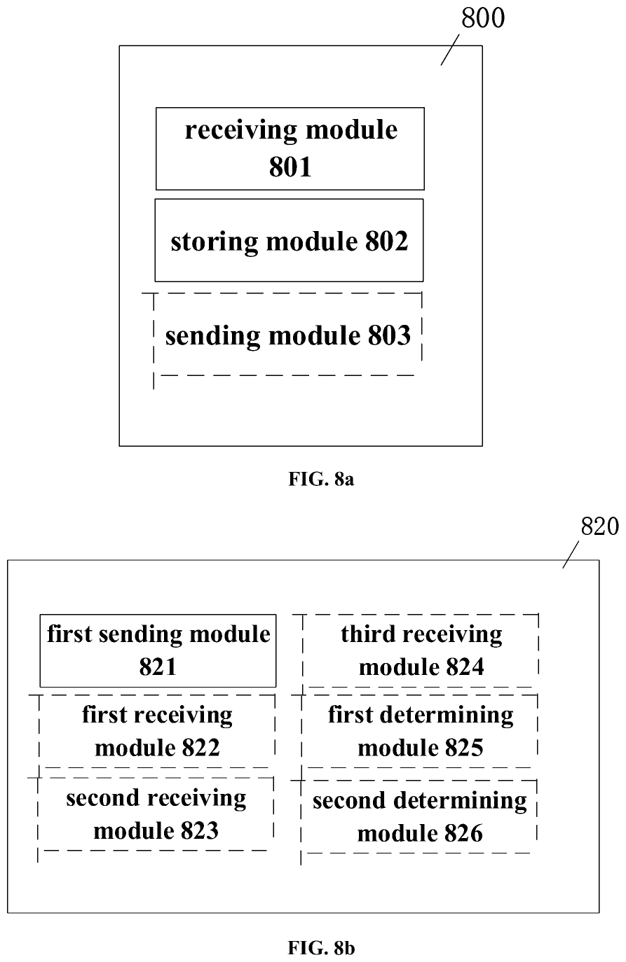

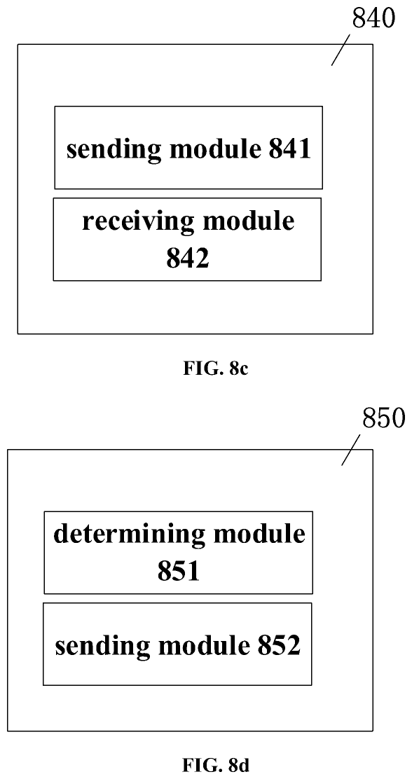

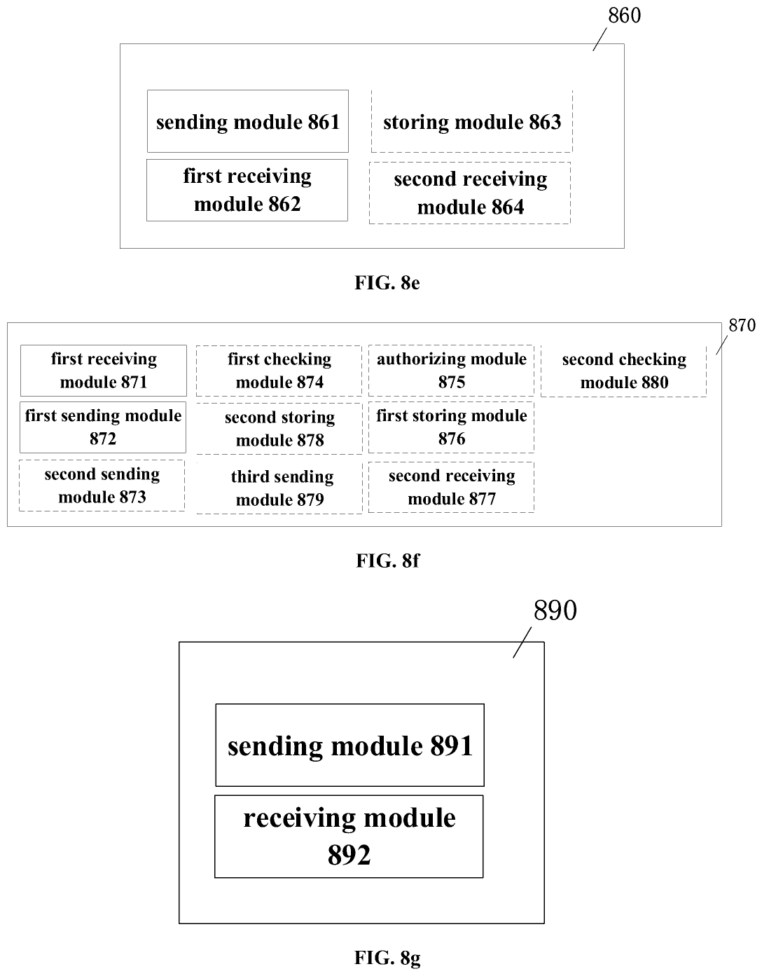

FIG. 6f shows a flowchart of EAS information provisioning according to another embodiment of the present disclosure, which is same as Figure 8.15.2.2-1 of 3GPP 23.558 V18.2.0.

FIG. 6f also depicts the timing to trigger EES to store or inform the selected EES information.

### Pre-Conditions:

1. The EEC has performed service provisioning procedure,
2. The EEC has performed the EAS discovery procedure.

Step 1. The EEC sends the EAS information provisioning request to the EES.

Step 2. Upon receiving the request from the EEC, the EES validates the EEC information request and verifies if the EEC is authorized for this operation.

Step 3. If the processing of the request was successful, the EES sends an EAS information provisioning response to the EEC indicating a successful status.

More detailed description of these steps can be found in clause 8.15 of 3GPP 23.558 V18.2.0.

As described in clause 8.15 of 3GPP 23.558 V18.2.0, the EEC can inform EES about the selected EES after EAS discovery procedure, then upon receiving the EAS information provisioning request, the EES may store the selected EES information e.g. in a central repository or inform the selected EES information to the CAS directly.

FIG. 6g shows a flowchart of EAS discovery procedure according to another embodiment of the present disclosure, which is same as Figure 8.5.2.2-1 of 3GPP 23.558 V18.2.0. The detailed description of steps of FIG. 6g can be found in clause 8.5.2.2 of 3GPP 23.558 V18.2.0.

Step 1. The EEC sends an EAS discovery request to the EES. The EAS discovery request includes the requestor identifier [EECID] along with the security credentials and may include EAS discovery filters and may also include UE location to retrieve information about particular EAS(s) or a category of EASs, e.g. gaming applications, or Edge Applications Server(s) available in certain service areas, e.g. available on a UE's predicted or expected route. The request may include an EAS selection request indicator or UE type.

Step 2. Upon receiving the request from the EEC, the EES checks if the EEC is authorized to discover the requested EAS(s).

If the EEC provides in the EAS discovery request the EAS selection request indicator, the EES selects EAS satisfying the EAS discovery filter or based on other information (e.g. ECSP policy) as described above (if no EAS discovery filter received), and then provides the selected EAS information to the EEC in the discovered EAS list of EAS discovery response.

Step 3. If the processing of the request was successful, the EES sends an EAS discovery response to the EEC, which includes information about the discovered EASs and Instantiable EAS Information.

For the ACR scenarios from edge to cloud, FIG. 6g is still valid with the difference that the EES may store the selected EES information in the central repository and/or inform the selected EES information to the CAS directly.

FIG. 6h shows a flowchart of the service continuity from cloud to edge with CAS decided ACR scenario according to another embodiment of the present disclosure.

Pre-condition: the CAS knows the old EES (i.e. the 1st EES) and subscribes to the old EES to receive ACR management events from the old EES, i.e. “ACR monitoring” events as described in clause 8.6.3 of 3GPP 23.558 V18.2.0, to detect the need for an ACR.

### Phase I: ACR Detection

Step 1. The CAS may receive ACR management notifications from source Edge Enabler Sever indicating that ACR may be required (“ACR monitoring” event), the notification also contains the T-EAS information (see clause 8.6.3.2.3 of 3GPP 23.558 V18.2.0).

### Phase II: ACR Decision

Step 2. The CAS makes the decision to perform the ACR.

### Phase III: ACR Execution

Step 3. After CAS determines the T-EAS to use, the S-EAS may apply the AF traffic influence with the N6 routing information of the T-EAS in the 3GPP Core Network (if applicable). The CAS sends selected T-EAS declaration message to the old EES, to inform the old EES the determined T-EAS to use as described in clause 8.8.3.7 of 3GPP 23.558 V18.2.0.

Step 4. If the T-EES is different than the old EES and the EEC Context at the old EES is not stale, the old EES initiates EEC Context Push relocation with the T-EES as described in clause 8.9.2.3 of 3GPP 23.558 V18.2.0. Otherwise, if the T-EES is the same as the old EES, EEC Context Push relocation is skipped.

Step 5. Based on the T-EAS selection information received from the CAS, the old EES sends the target information notification to the EEC as described in clause 8.8.3.5.3 of 3GPP 23.558 V18.2.0. The selected T-EES may be included in the target information and the ACID which corresponds to the selected target EAS is included in the notification sent to the EEC as described in clause 8.8.3.5.3 of 3GPP 23.558 V18.2.0.

If the old EES cannot send the notification to EEC (i.e. UE is not within the service area of the old EES), the old EES sends the notification via the 3GPP core network by Application Triggering.

Step 6. The CAS transfers the application context to the T-EAS. This process is out of scope of the present specification.

### Phase IV: Post-ACR Clean Up

Step 7. The CAS sends the ACR status update message to the old EES as specified in clause 8.8.3.8 of 3GPP 23.558 V18.2.0.

Step 8. The T-EAS sends the ACR status update message to the T-EES as specified in clause 8.8.3.8 of 3GPP 23.558 V18.2.0.

Step 9. The old EES sends ACR complete notification to the EEC.

If the old EES cannot send the notification to EEC (i.e. UE is not within the service area of the old EES), the old EES sends the notification via the 3GPP core network by Application Triggering.

FIG. 6i shows a flowchart of the service continuity from cloud to edge with old EES executed ACR scenario according to another embodiment of the present disclosure.

### Pre-condition:

1. The AC at the UE already has a connection to the CAS,
2. The CAS knows the old EES (i.e. the 1st EES).

Step 1. The CAS subscribes to receive ACR management notifications for “ACR facilitation” events to the old EES, in order to enable ACR detection.

### Phase I: ACR Detection

Step 2. The old EES detects that ACR may be required by the User Plane path change notification received from the 3GPP Core Network due to CAS request for “ACR facilitation” event (see clause 8.6.3 of 3GPP 23.558 V18.2.0).

### Phase II: ACR Decision

Step 3. The old EES decides to execute ACR.

### Phase III: ACR Execution

Step 4. If required, the old EES performs ACR parameter information procedure by sending the ACR parameter information request to the T-EES as described in clause 8.8.3.9 of 3GPP 23.558 V18.2.0.

Step 5. If the T-EES is different than the old EES and the EEC Context at the old EES is not stale, the old EES initiates EEC Context Push relocation with the T-EES as described in clause 8.9.2.3 of 3GPP 23.558 V18.2.0. Otherwise, if the T-EES is the same as the old EES, EEC Context Push relocation is skipped.

Step 6. The old EES sends the target information notification to the EEC as described in clause 8.8.3.5.3 of 3GPP 23.558 V18.2.0.

If the old EES cannot send the notification to EEC (i.e. UE is not within the service area of the old EES), the old EES sends the notification via the 3GPP core network by Application Triggering.

Step 7. The old EES may apply the AF traffic influence with the N6 routing information of the T-EAS in the 3GPP Core Network (if applicable).

Step 8. The old EES sends the ACR management notification (as notification for “ACR facilitation” event) to the CAS to initiate ACT between the CAS and the T-EAS.

Step 9. The Application Context is transferred from S-EAS to the T-EAS at implementation specific time, the specification of such process is out of scope of the present document.

### Phase IV: Post-ACR Clean Up

Step 10. The CAS sends the ACT status update message to the old EES as specified in clause 8.8.3.8 of 3GPP 23.558 V18.2.0.

Step 11. The T-EAS sends the ACR status update message to the T-EES as specified in clause 8.8.3.8 of 3GPP 23.558 V18.2.0.

Step 12. The old EES sends ACR complete notification to the EEC.

If the old EES cannot send the notification to EEC (i.e. UE is not within the service area of the old EES), the old EES sends the notification via the 3GPP core network by Application Triggering.

FIG. 6j shows a flowchart of the interactions between the EES and the CAS for the selected EES declaration according to another embodiment of the present disclosure.

Pre-conditions: A serving EES is selected for the EEC and the serving EES decides to inform CAS.

Step 1. The EES sends Selected EES declaration request message to the CAS. The request includes the information of the selected EES and may include ACID to indicate which AC the EES is intended for.

Step 2. The CAS checks whether the requesting EES is authorized to perform operation. If authorized, the CAS stores the received information.

Step 3. The CAS responds the request with Selected EES notification declaration response message.

The CAS, after knowing the selected EES for the UE, may subscribe to receive ACT status notifications as described in clause 8.8.3.6.2.3 of 3GPP 23.558 V18.2.0 for EELManagedACR, or trigger service continuity procedures towards the selected EES or subscribe to receive ACR management notification e.g. with ACT start event as described in clause 8.6.3.3.4 of 3GPP 23.558 V18.2.0.

Table 8.8.4.x1-1 describes an example of information elements for the selected EES declaration request sent from the EES to the CAS. It is noted that in addition to information elements in Table 8.8.4.x1-1, other information elements with the similar/same meanings may also be used. Table 8.8.4.x1-1 may comprise any other suitable information element. Table 8.8.4.x1-1 may comprise more or less suitable information elements.

TABLE 8.8.4.x1-1
Selected EES declaration request

| Information element | Status | Description |
|---|---|---|
| Security credentials | M | Security credentials resulting from a |
| | | successful authorization for the edge |
| | | computing service. |
| UE ID | M | The identifier of the UE. |
| Selected EES ID | M | Selected EES identifier. |
| Selected EES Endpoint | M | Endpoint of the selected EES. |
| EAS ID | M | The identifier of the EAS. |
| AC ID | O | The identifier of the AC. |

Table 8.8.4.x2-1 describes information elements for the selected EES declaration response sent from the CAS to the EES. It is noted that in addition to information elements in Table 8.8.4.x2-1, other information elements with the similar/same meanings may also be used. Table 8.8.4.x2-1 may comprise any other suitable information element. Table 8.8.4.x2-1 may comprise more or less suitable information elements.

TABLE 8.8.4.x2-1
Selected EES declaration response

| Information element | Status | Description |
|---|---|---|
| Successful response (NOTE) | O | Indicates that the request was |
| | | successful. |
| Failure response (NOTE) | O | Indicates that the request failed. |
| >Cause | O | Indicates the failure cause. |

(NOTE):
One of these IEs shall be present in the message.

FIG. 6k shows a flowchart of the interactions between the EES and the central repository for the selected EES declaration according to another embodiment of the present disclosure.

Pre-conditions: A serving EES is selected for the EEC and the serving EES decides to inform the central repository.

Step 1. The EES sends Selected EES declaration request message to the central repository. The request includes the information of the selected EES and may include ACID to indicate which AC the EES is intended for.

Step 2. The central repository checks whether the requesting EES is authorized to perform operation. If authorized, the central repository stores the received information.

Step 3. The central repository responds the request with selected EES declaration response message.

FIG. 6l shows a flowchart of the interactions between the CAS and the central repository for the selected EES retrieval according to another embodiment of the present disclosure.

Pre-conditions: The CAS is serving the AC.

Step 1. The CAS sends Selected EES retrieval request message to the central repository. The request includes EAS ID and UE ID, and may include AC ID.

Step 2. The central repository checks whether the requesting CAS is authorized to perform operation. If authorized, the central repository checks the stored information about the selected EES based on the received parameters.

Step 3. The central repository responds the request with Selected EES retrieval response message.

The CAS, after knowing the selected EES for the UE, may trigger service continuity procedures towards the selected EES.

FIG. 6m shows a flowchart of subscribing selected EES according to another embodiment of the present disclosure.

Step 1. The CAS sends selected EES subscription request message to the central repository. The request message includes EES selection event and EAS ID and may include UE ID and AC ID.

Step 2. Upon receiving the request, the central repository authorizes the request and store the event subscription.

Step 3. If the processing of the request was successful, the central repository responds the CAS with Selected EES subscription response message.

FIG. 6n shows a flowchart of selected EES subscription notification according to another embodiment of the present disclosure.

Pre-conditions: The CAS has subscribed with the central repository for the EES selection event as specified in FIG. 6m.

Step 1. An event occurs at the central repository that satisfies trigger conditions for notifying a subscribed CAS, e.g. the central repository is aware of selected EES for the UE.

Step 2. The central repository sends Selected EES notification to the CAS with the selected EES determined in step 1.

The CAS, after knowing the selected EES for the UE, may subscribe to receive ACT status notifications as described in clause 8.8.3.6.2.3 of 3GPP 23.558 V18.2.0 for EELManagedACR, or trigger service continuity procedures towards the selected EES or subscribe to receive ACR management notification with ACT start event as described in clause 8.6.3.3.4 of 3GPP 23.558 V18.2.0.

Table 8.Y.3.9-1 describes the information elements for Selected EES retrieval request from the CAS to the central repository. It is noted that in addition to information elements in Table 8.Y.3.9-1, other information elements with the similar/same meanings may also be used. Table 8.Y.3.9-1 may comprise any other suitable information element. Table 8.Y.3.9-1 may comprise more or less suitable information elements.

TABLE 8.Y.3.9-1
Selected EES retrieval request

| Information element | Status | Description |
|---|---|---|
| Requestor | M | The identifier of the CAS. |
| identifier | | |
| Security | M | Security credentials resulting from a |
| credentials | | successful authorization for the edge |
| | | computing service. |
| EAS ID | M | The identifier of the EAS. |
| UE ID | M | The identifier of the UE. |
| AC ID | O | The identifier of the UE. |

Table 8.Y.3.10-1 describes the information elements for Selected EES retrieval response from the central repository to the CAS. It is noted that in addition to information elements in Table 8.Y.3.10-1, other information elements with the similar/same meanings may also be used. Table 8.Y.3.10-1 may comprise any other suitable information element. Table 8.Y.3.10-1may comprise more or less suitable information elements.

TABLE 8.Y.3.10-1
Selected EES retrieval response

| Information element | Status | Description |
|---|---|---|
| Successful response | O | Indicates that the request was |
| (NOTE) | | successful. |
| >Selected EES ID | M | Selected EES identifier. |
| >Selected EES | M | Endpoint of the selected EES. |
| Endpoint | | |
| Failure response | O | Indicates that the request has failed. |
| (NOTE) | | |
| >Cause | O | Indicates the failure cause. Only |
| | | included when Failure response is |
| | | included. |

(NOTE):
One of these IEs shall be present in the message.

Table 8.Y.3.11-1 describes the information elements for Selected EES subscribe request from the CAS to the central repository. It is noted that in addition to information elements in Table 8.Y.3.11-1, other information elements with the similar/same meanings may also be used. Table 8. Y.3.11-1 may comprise any other suitable information element. Table 8.Y.3.11-1 may comprise more or less suitable information elements.

TABLE 8.Y.3.11-1
Selected EES subscribe request

| Information | | |
|---|---|---|
| element | Status | Description |
| Requestor | M | The identifier of the CAS. |
| identifier | | |
| Security | M | Security credentials resulting from a |
| credentials | | successful authorization for the edge |
| | | computing service. |
| Notification | M | Notification Target Address where the |
| Target Address | | notification is to be sent. |
| Event ID | M | Event ID: |
| | | EES selection |
| EES selection | O | Applicable for event “EES selection” |
| info | | event. |
| >EAS ID | M | The identifier of the EAS. |
| >UE ID | O | The identifier of the UE. If omitted, it |
| | | implies any UE. |
| >AC ID | O | The identifier of the AC. If omitted, it |
| | | implies any AC. |

Table 8.Y.3.12-1 describes the information elements for Selected EES subscribe response from the central repository to the CAS. It is noted that in addition to information elements in Table 8.Y.3.12-1, other information elements with the similar/same meanings may also be used. Table 8.Y.3.12-1 may comprise any other suitable information element. Table 8.Y.3.12-1 may comprise more or less suitable information elements.

TABLE 8.Y.3.12-1
Selected EES subscribe response

| Information element | Status | Description |
|---|---|---|
| Successful | O | Indicates that the request was successful. |
| response (NOTE) | | |
| >Subscription ID | M | Subscription identifier corresponding to |
| | | the subscription. |
| Failure | O | Indicates that the request has failed. |
| response (NOTE) | | |
| >Cause | O | Indicates the failure cause. Only included |
| | | when Failure response is included. |

(NOTE):
One of these IEs shall be present in the message.

Table 8.Y.3.13-1 describes the information elements for Selected EES notification from the central repository to the CAS. It is noted that in addition to information elements in Table 8.Y.3.13-1, other information elements with the similar/same meanings may also be used. Table 8.Y.3.13-1 may comprise any other suitable information element. Table 8.Y.3.13-1 may comprise more or less suitable information elements.

TABLE 8.Y.3.13-1
Selected EES notification

| Information | | |
|---|---|---|
| element | Status | Description |
| Subscription ID | M | Subscription identifier corresponding to |
| | | the subscription. |
| Event ID | M | Identify the subscribed event. |
| EES selection | O | Applicable for event “EES selection” |
| info | | event. |
| >UE ID | M | The identifier of the UE. |
| >Selected EES ID | M | Selected EES identifier. |
| >Selected EES | M | Endpoint of the selected EES. |
| Endpoint | | |
| >EAS ID | M | The identifier of the EAS. |
| >AC ID | O | The identifier of the AC. |

In an embodiment, the AC indicates the T-EAS is a CAS in the ACR request towards the EEC.

In an embodiment, ACR request is enhanced with new indication to inform CAS.

In an embodiment, S-EES informs CAS about its presence.

In an embodiment, the EES (such as S-EES or old EES) may store the serving EES information in the central repository so that the CAS can obtain the serving EES information or be notified about the serving EES information from the central repository.

In an embodiment, alternative to inform the selected EES to the CAS is to use the central repository.

Embodiments herein may provide many advantages, of which a non-exhaustive list of examples follows. In some embodiments herein, it may enable the CAS to know the selected EES in EDN. In some embodiments herein, it provides functionality in EDGEAPP to support service continuity. In some embodiments herein, it enables the CAS to utilize the needed EEL service for instance subscribe to receive ACT status notifications in S-EES executed ACR scenario for EELManagedACR and/or trigger CAS decided ACR. In some embodiments herein, it solves the issue when CAS needs to relocate application context but doesn't know the EES to start T-EAS discovery and selected T-EAS declaration procedures. In some embodiments herein, it also allows the CAS to contact the EES (e.g. ACR facilitation as described in 3GPP TS 23.558 V17.3.0, clause 8.6.3 and clause 8.8.2.5) to start with EES executed ACR scenario. The embodiments herein are not limited to the features and advantages mentioned above. A person skilled in the art will recognize additional features and advantages upon reading the following detailed description.

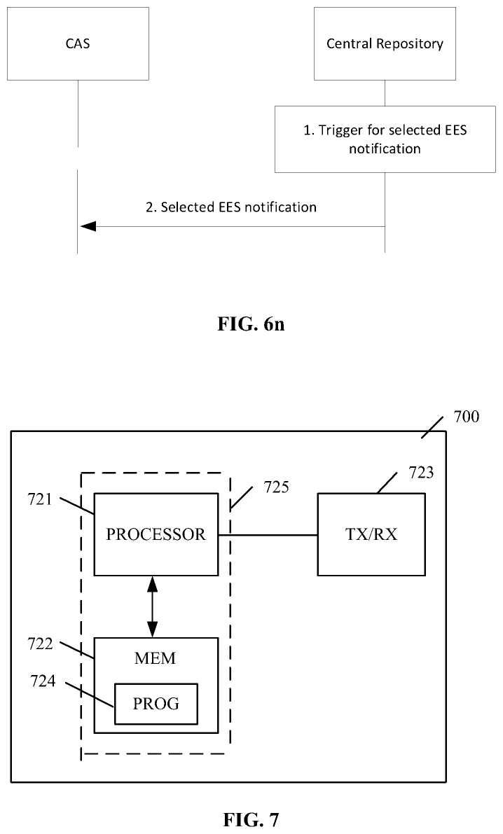

FIG. 7 is a block diagram showing an apparatus suitable for practicing some embodiments of the disclosure. For example, any one of EES, EEC, AC, central repository or CAS described above may be implemented as or through the apparatus 700.

The apparatus 700 comprises at least one processor 721, such as a digital processor (DP), and at least one memory (MEM) 722 coupled to the processor 721. The apparatus 700 may further comprise a transmitter TX and receiver RX 723 coupled to the processor 721. The MEM 722 stores a program (PROG) 724. The PROG 724 may include instructions that, when executed on the associated processor 721, enable the apparatus 700 to operate in accordance with the embodiments of the present disclosure. A combination of the at least one processor 721 and the at least one MEM 722 may form processing means 725 adapted to implement various embodiments of the present disclosure.

Various embodiments of the present disclosure may be implemented by computer program executable by one or more of the processor 721, software, firmware, hardware or in a combination thereof.

The MEM 722 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 721 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the EES, the memory 722 contains instructions executable by the processor 721, whereby the EES operates according to any of the methods performed by the EES as described above.

In an embodiment where the apparatus is implemented as or at the EEC, the memory 722 contains instructions executable by the processor 721, whereby the EEC operates according to any of the methods performed by the EEC as described above.

In an embodiment where the apparatus is implemented as or at the CAS, the memory 722 contains instructions executable by the processor 721, whereby the CAS operates according to any of the methods performed by the CAS as described above.

In an embodiment where the apparatus is implemented as or at the AC, the memory 722 contains instructions executable by the processor 721, whereby the AC operates according to any of the methods performed by the AC as described above.

In an embodiment where the apparatus is implemented as or at the central repository, the memory 722 contains instructions executable by the processor 721, whereby the central repository operates according to any of the methods performed by the central repository as described above.

FIG. 8a is a block diagram showing a CAS according to an embodiment of the disclosure. As shown, the CAS 800 comprises a receiving module 801 configured to receive a first request from an edge enabler server (EES) selected for an edge enabler client (EEC) of a user equipment (UE) during a procedure of application context relocation (ACR) or after the EES receiving an edge application server (EAS) information provisioning request. The first request comprises endpoint information of the EES. The CAS 800 may further comprise a storing module 802 configured to store the endpoint information of the EES.

In an embodiment, the CAS 800 may further comprise a sending module 803 configured to send a first response to the EES.

FIG. 8b is a block diagram showing an EES 820 according to an embodiment of the disclosure. As shown, the EES 820 comprises a first sending module 821 configured to send a first request to a cloud application server (CAS) during a procedure of application context relocation (ACR) or after the EES receiving an edge application server (EAS) information provisioning request. The first request comprises endpoint information of the EES.

In an embodiment, the EES 820 may further comprise a first receiving module 822 configured to receive a first response from the CAS.

In an embodiment, the EES 820 may further comprise a second receiving module 823 configured to receive a first ACR request from an edge enabler client (EEC). The first ACR request comprises information indicating that EES informs the CAS with the endpoint information of the EES.

In an embodiment, the EES 820 may further comprise a third receiving module 824 configured to receive a selected CAS declaration message from a source EAS. The selected CAS declaration message informs the EES a determined CAS to use.

In an embodiment, the EES 820 may further comprise a first determining module 825 configured to determine that no relevant EAS is available for a location of a user equipment.

In an embodiment, the EES 820 may further comprise a second determining module 826 configured to determine the CAS.

FIG. 8c is a block diagram showing an EEC according to another embodiment of the disclosure. As shown, the EEC 840 comprises a sending module 841 configured to send a first application context relocation (ACR) request to an edge enabler server (EES) selected for an edge enabler client (EEC) of a user equipment (UE) during a procedure of ACR. The first ACR request comprises information indicating that EES informs a cloud application server (CAS) with endpoint information of the EES.

In an embodiment, the EEC 840 may further comprise a receiving module 842 configured to receive a second ACR request from an application client (AC). The second ACR request comprises information indicating that an included target EAS is CAS.

FIG. 8d is a block diagram showing an AC according to another embodiment of the disclosure. As shown, the AC 850 comprises a determining module 851 configured to determine a cloud application server (CAS). The AC 850 may further comprise a sending module 852 configured to send a second application context relocation (ACR) request to an edge enabler client (EEC) during a procedure of ACR. The second ACR request comprises information indicating that an included target edge application server (EAS) is CAS.

FIG. 8e is a block diagram showing a CAS according to another embodiment of the disclosure. As shown, the CAS 860 comprises a sending module 861 configured to send a first request to a central repository. The first request may be used for retrieving information of an edge enabler server (EES) selected for an edge enabler client (EEC) of a user equipment (UE) or subscribing for the information of the EES selected for the EEC of the UE. The CAS 860 may further comprise a first receiving module 862 configured to receive a first message from the central repository.

In an embodiment, the CAS 860 may further comprise a storing module 863 configured to store the information of the EES selected for the EEC of the UE.

In an embodiment, when the first request is a selected EES subscription request message, the CAS 860 may further comprise a second receiving module 864 configured to receive a selected EES subscription response from the central repository.

FIG. 8f is a block diagram showing a central repository according to an embodiment of the disclosure. As shown, the central repository 870 comprises a first receiving module 871 configured to receive a first request from a cloud application server (CAS). The first request may be used for retrieving information of an edge enabler server (EES) selected for an edge enabler client (EEC) of a user equipment (UE) or subscribing for the information of the EES selected for the EEC of the UE. The central repository 870 may further comprise a first sending module 872 configured to send a first message to the CAS.

In an embodiment, when the first request is a selected EES subscription request message, the central repository 870 may further comprise a second sending module 873 configured to send a selected EES subscription response to the CAS.

In an embodiment, when the first request is a selected EES retrieval request, the central repository 870 may further comprise a first checking module 874 configured to check whether the CAS is authorized to perform a retrieving operation. When the CAS is authorized to perform the retrieving operation, the first message may comprise a retrieving result.

In an embodiment, when the first request is a selected EES subscription request, the central repository 870 may further comprise an authorizing module 875 configured to authorize the first request. The central repository 870 may further comprise a first storing module 876 configured to store event subscription when the first request is authorized.

In an embodiment, the central repository 870 may further comprise a second receiving module 877 configured to receive a second request from the EES selected for the EEC of the UE. The second request may comprise the information of the EES selected for the EEC of the UE. The central repository 870 may further comprise a second storing module 878 configured to storing the information of the EES selected for the EEC of the UE. The central repository 870 may further comprise a third sending module 879 configured to send a second response to the EES selected for the EEC of the UE.

In an embodiment, the central repository 870 may further comprise a second checking module 880 configured to check whether the EES selected for the EEC of the UE is authorized to perform a storing operation. When the EES selected for the EEC of the UE is authorized to perform the storing operation, the central repository may store the information of the EES selected for the EEC of the UE.

FIG. 8g is a block diagram showing an EES 890 according to another embodiment of the disclosure. As shown, the EES 890 comprises a sending module 891 configured to send a second request to a central repository. The second request may comprise the information of the EES which is selected for an edge enabler client (EEC) of a user equipment (UE). The EES 890 may further comprise a receiving module 892 configured to receive a second response from the central repository.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the EES, EEC, AC, central repository or CAS may not need a fixed processor or memory, any computing resource and storage resource may be arranged from the EES, EEC, AC, central repository or CAS in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

Further, the exemplary overall commutation system including the terminal device and the network node will be introduced as below.

Embodiments of the present disclosure provide a communication system including a host computer including: processing circuitry configured to provide user data; and a communication interface configured to forward the user data to a cellular network for transmission to a terminal device. The cellular network includes a base station, and/or the terminal device such as the AC or EEC above mentioned.

In embodiments of the present disclosure, the system further includes the terminal device. The terminal device is configured to communicate with the base station.

In embodiments of the present disclosure, the processing circuitry of the host computer is configured to execute a host application, thereby providing the user data; and the terminal device includes processing circuitry configured to execute a client application associated with the host application.

Embodiments of the present disclosure also provide a communication system including a host computer including: a communication interface configured to receive user data originating from a transmission from a terminal device; a base station. The transmission is from the terminal device to the base station.

In embodiments of the present disclosure, the processing circuitry of the host computer is configured to execute a host application. The terminal device is configured to execute a client application associated with the host application, thereby providing the user data to be received by the host computer.

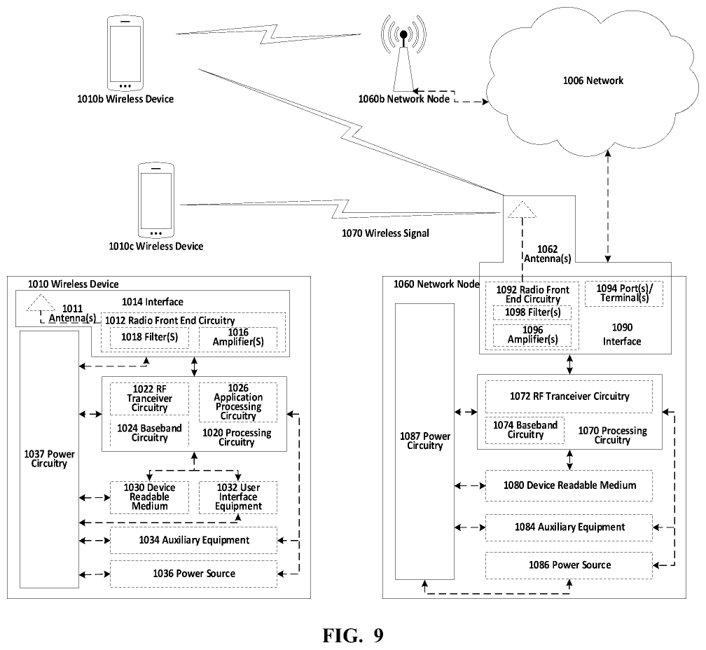

FIG. 9 is a schematic showing a wireless network in accordance with some embodiments.

Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 1006, network nodes 1060 (corresponding to network side node) and 1060b, and WDs (corresponding to terminal device) 1010, 1010b, and 1010c. In practice, a wireless network may further include any additional elements suitable to support communication between wireless devices or between a wireless device and another communication device, such as a landline telephone, a service provider, or any other network node or end device. Of the illustrated components, network node 1060 and wireless device (WD) 1010 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1006 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1060 and WD 1010 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 9, network node 1060 includes processing circuitry 1070, device readable medium 1080, interface 1090, auxiliary equipment 1084, power source 1086, power circuitry 1087, and antenna 1062. Although network node 1060 illustrated in the example wireless network of FIG. 9 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1060 are depicted as single boxes located within a larger box, or nested within multiple boxes, in practice, a network node may comprise multiple different physical components that make up a single illustrated component (e.g., device readable medium 1080 may comprise multiple separate hard drives as well as multiple RAM modules).

Similarly, network node 1060 may be composed of multiple physically separate components (e.g., a NodeB component and a RNC component, or a BTS component and a BSC component, etc.), which may each have their own respective components. In certain scenarios in which network node 1060 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1060 may be configured to support multiple radio access technologies (RATs). In such embodiments, some components may be duplicated (e.g., separate device readable medium 1080 for the different RATs) and some components may be reused (e.g., the same antenna 1062 may be shared by the RATs). Network node 1060 may also include multiple sets of the various illustrated components for different wireless technologies integrated into network node 1060, such as, for example, GSM, WCDMA, LTE, NR, WiFi, or Bluetooth wireless technologies. These wireless technologies may be integrated into the same or different chip or set of chips and other components within network node 1060.

Processing circuitry 1070 is configured to perform any determining, calculating, or similar operations (e.g., certain obtaining operations) described herein as being provided by a network node. These operations performed by processing circuitry 1070 may include processing information obtained by processing circuitry 1070 by, for example, converting the obtained information into other information, comparing the obtained information or converted information to information stored in the network node, and/or performing one or more operations based on the obtained information or converted information, and as a result of said processing making a determination.

Processing circuitry 1070 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1060 components, such as device readable medium 1080, network node 1060 functionality. For example, processing circuitry 1070 may execute instructions stored in device readable medium 1080 or in memory within processing circuitry 1070. Such functionality may include providing any of the various wireless features, functions, or benefits discussed herein. In some embodiments, processing circuitry 1070 may include a system on a chip (SOC).

In some embodiments, processing circuitry 1070 may include one or more of radio frequency (RF) transceiver circuitry 1072 and baseband processing circuitry 1074. In some embodiments, radio frequency (RF) transceiver circuitry 1072 and baseband processing circuitry 1074 may be on separate chips (or sets of chips), boards, or units, such as radio units and digital units. In alternative embodiments, part or all of RF transceiver circuitry 1072 and baseband processing circuitry 1074 may be on the same chip or set of chips, boards, or units

In certain embodiments, some or all of the functionality described herein as being provided by a network node, base station, eNB or other such network node may be performed by processing circuitry 1070 executing instructions stored on device readable medium 1080 or memory within processing circuitry 1070. In alternative embodiments, some or all of the functionality may be provided by processing circuitry 1070 without executing instructions stored on a separate or discrete device readable medium, such as in a hard-wired manner. In any of those embodiments, whether executing instructions stored on a device readable storage medium or not, processing circuitry 1070 can be configured to perform the described functionality. The benefits provided by such functionality are not limited to processing circuitry 1070 alone or to other components of network node 1060, but are enjoyed by network node 1060 as a whole, and/or by end users and the wireless network generally.

Device readable medium 1080 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1070. Device readable medium 1080 may store any suitable instructions, data or information, including a computer program, software, an application including one or more of logic, rules, code, tables, etc. and/or other instructions capable of being executed by processing circuitry 1070 and, utilized by network node 1060. Device readable medium 1080 may be used to store any calculations made by processing circuitry 1070 and/or any data received via interface 1090. In some embodiments, processing circuitry 1070 and device readable medium 1080 may be considered to be integrated.

Interface 1090 is used in the wired or wireless communication of signalling and/or data between network node 1060, network 1006, and/or WDs 1010. As illustrated, interface 1090 comprises port(s)/terminal(s) 1094 to send and receive data, for example to and from network 1006 over a wired connection. Interface 1090 also includes radio front end circuitry 1092 that may be coupled to, or in certain embodiments a part of, antenna 1062. Radio front end circuitry 1092 comprises filters 1098 and amplifiers 1096. Radio front end circuitry 1092 may be connected to antenna 1062 and processing circuitry 1070. Radio front end circuitry may be configured to condition signals communicated between antenna 1062 and processing circuitry 1070. Radio front end circuitry 1092 may receive digital data that is to be sent out to other network nodes or WDs via a wireless connection. Radio front end circuitry 1092 may convert the digital data into a radio signal having the appropriate channel and bandwidth parameters using a combination of filters 1098 and/or amplifiers 1096. The radio signal may then be transmitted via antenna 1062. Similarly, when receiving data, antenna 1062 may collect radio signals which are then converted into digital data by radio front end circuitry 1092. The digital data may be passed to processing circuitry 1070. In other embodiments, the interface may comprise different components and/or different combinations of components.

In certain alternative embodiments, network node 1060 may not include separate radio front end circuitry 1092, instead, processing circuitry 1070 may comprise radio front end circuitry and may be connected to antenna 1062 without separate radio front end circuitry 1092. Similarly, in some embodiments, all or some of RF transceiver circuitry 1072 may be considered a part of interface 1090. In still other embodiments, interface 1090 may include one or more ports or terminals 1094, radio front end circuitry 1092, and RF transceiver circuitry 1072, as part of a radio unit (not shown), and interface 1090 may communicate with baseband processing circuitry 1074, which is part of a digital unit (not shown).

Antenna 1062 may include one or more antennas, or antenna arrays, configured to send and/or receive wireless signals. Antenna 1062 may be coupled to radio front end circuitry 1090 and may be any type of antenna capable of transmitting and receiving data and/or signals wirelessly. In some embodiments, antenna 1062 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1062 may be separate from network node 1060 and may be connectable to network node 1060 through an interface or port.

Antenna 1062, interface 1090, and/or processing circuitry 1070 may be configured to perform any receiving operations and/or certain obtaining operations described herein as being performed by a network node. Any information, data and/or signals may be received from a wireless device, another network node and/or any other network equipment. Similarly, antenna 1062, interface 1090, and/or processing circuitry 1070 may be configured to perform any transmitting operations described herein as being performed by a network node. Any information, data and/or signals may be transmitted to a wireless device, another network node and/or any other network equipment.

Power circuitry 1087 may comprise, or be coupled to, power management circuitry and is configured to supply the components of network node 1060 with power for performing the functionality described herein. Power circuitry 1087 may receive power from power source 1086. Power source 1086 and/or power circuitry 1087 may be configured to provide power to the various components of network node 1060 in a form suitable for the respective components (e.g., at a voltage and current level needed for each respective component). Power source 1086 may either be included in, or external to, power circuitry 1087 and/or network node 1060. For example, network node 1060 may be connectable to an external power source (e.g., an electricity outlet) via an input circuitry or interface such as an electrical cable, whereby the external power source supplies power to power circuitry 1087. As a further example, power source 1086 may comprise a source of power in the form of a battery or battery pack which is connected to, or integrated in, power circuitry 1087. The battery may provide backup power should the external power source fail. Other types of power sources, such as photovoltaic devices, may also be used.

Alternative embodiments of network node 1060 may include additional components beyond those shown in FIG. 9 that may be responsible for providing certain aspects of the network node's functionality, including any of the functionality described herein and/or any functionality necessary to support the subject matter described herein. For example, network node 1060 may include user interface equipment to allow input of information into network node 1060 and to allow output of information from network node 1060. This may allow a user to perform diagnostic, maintenance, repair, and other administrative functions for network node 1060.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1010 includes antenna 1011, interface 1014, processing circuitry 1020, device readable medium 1030, user interface equipment 1032, auxiliary equipment 1034, power source 1036 and power circuitry 1037. WD 1010 may include multiple sets of one or more of the illustrated components for different wireless technologies supported by WD 1010, such as, for example, GSM, WCDMA, LTE, NR, WiFi, WiMAX, or Bluetooth wireless technologies, just to mention a few. These wireless technologies may be integrated into the same or different chips or set of chips as other components within WD 1010.

Antenna 1011 may include one or more antennas or antenna arrays, configured to send and/or receive wireless signals, and is connected to interface 1014. In certain alternative embodiments, antenna 1011 may be separate from WD 1010 and be connectable to WD 1010 through an interface or port. Antenna 1011, interface 1014, and/or processing circuitry 1020 may be configured to perform any receiving or transmitting operations described herein as being performed by a WD. Any information, data and/or signals may be received from a network node and/or another WD. In some embodiments, radio front end circuitry and/or antenna 1011 may be considered an interface.

As illustrated, interface 1014 comprises radio front end circuitry 1012 and antenna 1011. Radio front end circuitry 1012 comprise one or more filters 1018 and amplifiers 1016. Radio front end circuitry 1014 is connected to antenna 1011 and processing circuitry 1020, and is configured to condition signals communicated between antenna 1011 and processing circuitry 1020. Radio front end circuitry 1012 may be coupled to or a part of antenna 1011. In some embodiments, WD 1010 may not include separate radio front end circuitry 1012; rather, processing circuitry 1020 may comprise radio front end circuitry and may be connected to antenna 1011. Similarly, in some embodiments, some or all of RF transceiver circuitry 1022 may be considered a part of interface 1014. Radio front end circuitry 1012 may receive digital data that is to be sent out to other network nodes or WDs via a wireless connection. Radio front end circuitry 1012 may convert the digital data into a radio signal having the appropriate channel and bandwidth parameters using a combination of filters 1018 and/or amplifiers 1016. The radio signal may then be transmitted via antenna 1011. Similarly, when receiving data, antenna 1011 may collect radio signals which are then converted into digital data by radio front end circuitry 1012. The digital data may be passed to processing circuitry 1020. In other embodiments, the interface may comprise different components and/or different combinations of components.

Processing circuitry 1020 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1010 components, such as device readable medium 1030, WD 1010 functionality. Such functionality may include providing any of the various wireless features or benefits discussed herein. For example, processing circuitry 1020 may execute instructions stored in device readable medium 1030 or in memory within processing circuitry 1020 to provide the functionality disclosed herein.

As illustrated, processing circuitry 1020 includes one or more of RF transceiver circuitry 1022, baseband processing circuitry 1024, and application processing circuitry 1026. In other embodiments, the processing circuitry may comprise different components and/or different combinations of components. In certain embodiments processing circuitry 1020 of WD 1010 may comprise a SOC. In some embodiments, RF transceiver circuitry 1022, baseband processing circuitry 1024, and application processing circuitry 1026 may be on separate chips or sets of chips. In alternative embodiments, part or all of baseband processing circuitry 1024 and application processing circuitry 1026 may be combined into one chip or set of chips, and RF transceiver circuitry 1022 may be on a separate chip or set of chips. In still alternative embodiments, part or all of RF transceiver circuitry 1022 and baseband processing circuitry 1024 may be on the same chip or set of chips, and application processing circuitry 1026 may be on a separate chip or set of chips. In yet other alternative embodiments, part or all of RF transceiver circuitry 1022, baseband processing circuitry 1024, and application processing circuitry 1026 may be combined in the same chip or set of chips. In some embodiments, RF transceiver circuitry 1022 may be a part of interface 1014. RF transceiver circuitry 1022 may condition RF signals for processing circuitry 1020.

In certain embodiments, some or all of the functionality described herein as being performed by a WD may be provided by processing circuitry 1020 executing instructions stored on device readable medium 1030, which in certain embodiments may be a computer-readable storage medium. In alternative embodiments, some or all of the functionality may be provided by processing circuitry 1020 without executing instructions stored on a separate or discrete device readable storage medium, such as in a hard-wired manner. In any of those particular embodiments, whether executing instructions stored on a device readable storage medium or not, processing circuitry 1020 can be configured to perform the described functionality. The benefits provided by such functionality are not limited to processing circuitry 1020 alone or to other components of WD 1010, but are enjoyed by WD 1010 as a whole, and/or by end users and the wireless network generally.

Processing circuitry 1020 may be configured to perform any determining, calculating, or similar operations (e.g., certain obtaining operations) described herein as being performed by a WD. These operations, as performed by processing circuitry 1020, may include processing information obtained by processing circuitry 1020 by, for example, converting the obtained information into other information, comparing the obtained information or converted information to information stored by WD 1010, and/or performing one or more operations based on the obtained information or converted information, and as a result of said processing making a determination.

Device readable medium 1030 may be operable to store a computer program, software, an application including one or more of logic, rules, code, tables, etc. and/or other instructions capable of being executed by processing circuitry 1020. Device readable medium 1030 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1020. In some embodiments, processing circuitry 1020 and device readable medium 1030 may be considered to be integrated.

User interface equipment 1032 may provide components that allow for a human user to interact with WD 1010. Such interaction may be of many forms, such as visual, audial, tactile, etc. User interface equipment 1032 may be operable to produce output to the user and to allow the user to provide input to WD 1010. The type of interaction may vary depending on the type of user interface equipment 1032 installed in WD 1010. For example, if WD 1010 is a smart phone, the interaction may be via a touch screen; if WD 1010 is a smart meter, the interaction may be through a screen that provides usage (e.g., the number of gallons used) or a speaker that provides an audible alert (e.g., if smoke is detected). User interface equipment 1032 may include input interfaces, devices and circuits, and output interfaces, devices and circuits. User interface equipment 1032 is configured to allow input of information into WD 1010, and is connected to processing circuitry 1020 to allow processing circuitry 1020 to process the input information. User interface equipment 1032 may include, for example, a microphone, a proximity or other sensor, keys/buttons, a touch display, one or more cameras, a USB port, or other input circuitry. User interface equipment 1032 is also configured to allow output of information from WD 1010, and to allow processing circuitry 1020 to output information from WD 1010. User interface equipment 1032 may include, for example, a speaker, a display, vibrating circuitry, a USB port, a headphone interface, or other output circuitry. Using one or more input and output interfaces, devices, and circuits, of user interface equipment 1032, WD 1010 may communicate with end users and/or the wireless network, and allow them to benefit from the functionality described herein.

Auxiliary equipment 1034 is operable to provide more specific functionality which may not be generally performed by WDs. This may comprise specialized sensors for doing measurements for various purposes, interfaces for additional types of communication such as wired communications etc. The inclusion and type of components of auxiliary equipment 1034 may vary depending on the embodiment and/or scenario.

Power source 1036 may, in some embodiments, be in the form of a battery or battery pack. Other types of power sources, such as an external power source (e.g., an electricity outlet), photovoltaic devices or power cells, may also be used. WD 1010 may further comprise power circuitry 1037 for delivering power from power source 1036 to the various parts of WD 1010 which need power from power source 1036 to carry out any functionality described or indicated herein. Power circuitry 1037 may in certain embodiments comprise power management circuitry. Power circuitry 1037 may additionally or alternatively be operable to receive power from an external power source; in which case WD 1010 may be connectable to the external power source (such as an electricity outlet) via input circuitry or an interface such as an electrical power cable. Power circuitry 1037 may also in certain embodiments be operable to deliver power from an external power source to power source 1036. This may be, for example, for the charging of power source 1036. Power circuitry 1037 may perform any formatting, converting, or other modification to the power from power source 1036 to make the power suitable for the respective components of WD 1010 to which power is supplied.

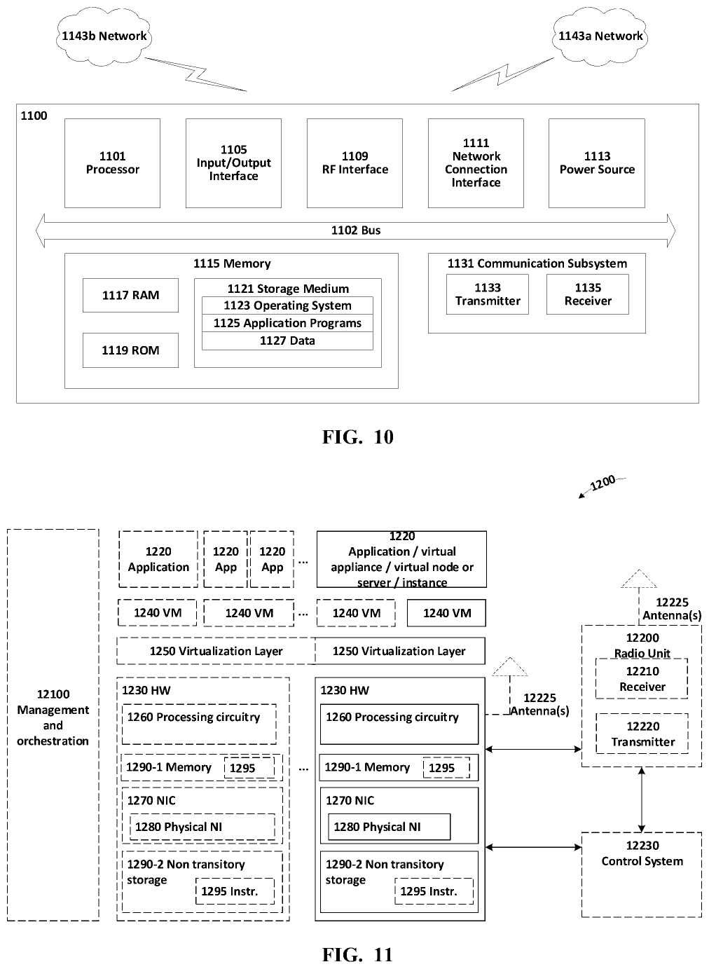

FIG. 10 is a schematic showing a user equipment in accordance with some embodiments.

FIG. 10 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1100 may be any UE identified by the 3rd Generation Partnership Project (3GPP), including a NB-IoT UE, a machine type communication (MTC) UE, and/or an enhanced MTC (eMTC) UE. UE 1100, as illustrated in FIG. 10, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 1100 includes processing circuitry 1101 that is operatively coupled to input/output interface 1105, radio frequency (RF) interface 1109, network connection interface 1111, memory 1115 including random access memory (RAM) 1117, read-only memory (ROM) 1119, and storage medium 1121 or the like, communication subsystem 1131, power source 1133, and/or any other component, or any combination thereof. Storage medium 1121 includes operating system 1123, application program 1125, and data 1127. In other embodiments, storage medium 1121 may include other similar types of information. Certain UEs may utilize all of the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 1101 may be configured to process computer instructions and data. Processing circuitry 1101 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1101 may include two central processing units (CPUs). Data may be information in a form suitable for use by a computer.

In the depicted embodiment, input/output interface 1105 may be configured to provide a communication interface to an input device, output device, or input and output device. UE 1100 may be configured to use an output device via input/output interface 1105. An output device may use the same type of interface port as an input device. For example, a USB port may be used to provide input to and output from UE 1100. The output device may be a speaker, a sound card, a video card, a display, a monitor, a printer, an actuator, an emitter, a smartcard, another output device, or any combination thereof. UE 1100 may be configured to use an input device via input/output interface 1105 to allow a user to capture information into UE 1100. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 1109 may be configured to provide a communication interface to RF components such as a transmitter, a receiver, and an antenna. Network connection interface 1111 may be configured to provide a communication interface to network 1143a. Network 1143a may encompass wired and/or wireless networks such as a local-area network (LAN), a wide-area network (WAN), a computer network, a wireless network, a telecommunications network, another like network or any combination thereof. For example, network 1143a may comprise a Wi-Fi network. Network connection interface 1111 may be configured to include a receiver and a transmitter interface used to communicate with one or more other devices over a communication network according to one or more communication protocols, such as Ethernet, TCP/IP, SONET, ATM, or the like. Network connection interface 1111 may implement receiver and transmitter functionality appropriate to the communication network links (e.g., optical, electrical, and the like). The transmitter and receiver functions may share circuit components, software or firmware, or alternatively may be implemented separately.

RAM 1117 may be configured to interface via bus 1102 to processing circuitry 1101 to provide storage or caching of data or computer instructions during the execution of software programs such as the operating system, application programs, and device drivers. ROM 1119 may be configured to provide computer instructions or data to processing circuitry 1101. For example, ROM 1119 may be configured to store invariant low-level system code or data for basic system functions such as basic input and output (I/O), startup, or reception of keystrokes from a keyboard that are stored in a non-volatile memory. Storage medium 1121 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1121 may be configured to include operating system 1123, application program 1125 such as a web browser application, a widget or gadget engine or another application, and data file 1127. Storage medium 1121 may store, for use by UE 1100, any of a variety of various operating systems or combinations of operating systems.

Storage medium 1121 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1121 may allow UE 1100 to access computer-executable instructions, application programs or the like, stored on transitory or non-transitory memory media, to off-load data, or to upload data. An article of manufacture, such as one utilizing a communication system may be tangibly embodied in storage medium 1121, which may comprise a device readable medium.

In FIG. 10, processing circuitry 1101 may be configured to communicate with network 1143b using communication subsystem 1131. Network 1143a and network 1143b may be the same network or networks or different network or networks. Communication subsystem 1131 may be configured to include one or more transceivers used to communicate with network 1143b. For example, communication subsystem 1131 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1133 and/or receiver 1135 to implement transmitter or receiver functionality, respectively, appropriate to the RAN links (e.g., frequency allocations and the like). Further, transmitter 1133 and receiver 1135 of each transceiver may share circuit components, software or firmware, or alternatively may be implemented separately.

In the illustrated embodiment, the communication functions of communication subsystem 1131 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1131 may include cellular communication, Wi-Fi communication, Bluetooth communication, and GPS communication. Network 1143b may encompass wired and/or wireless networks such as a local-area network (LAN), a wide-area network (WAN), a computer network, a wireless network, a telecommunications network, another like network or any combination thereof. For example, network 1143b may be a cellular network, a Wi-Fi network, and/or a near-field network. Power source 1113 may be configured to provide alternating current (AC) or direct current (DC) power to components of UE 1100.

The features, benefits and/or functions described herein may be implemented in one of the components of UE 1100 or partitioned across multiple components of UE 1100. Further, the features, benefits, and/or functions described herein may be implemented in any combination of hardware, software or firmware. In one example, communication subsystem 1131 may be configured to include any of the components described herein. Further, processing circuitry 1101 may be configured to communicate with any of such components over bus 1102. In another example, any of such components may be represented by program instructions stored in memory that when executed by processing circuitry 1101 perform the corresponding functions described herein. In another example, the functionality of any of such components may be partitioned between processing circuitry 1101 and communication subsystem 1131. In another example, the non-computationally intensive functions of any of such components may be implemented in software or firmware and the computationally intensive functions may be implemented in hardware.

FIG. 11 is a schematic showing a virtualization environment in accordance with some embodiments.

FIG. 11 is a schematic block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1200 hosted by one or more of hardware nodes 1230. Further, in embodiments in which the virtual node is not a radio access node or does not require radio connectivity (e.g., a core network node), then the network node may be entirely virtualized.

The functions may be implemented by one or more applications 1220 (which may alternatively be called software instances, virtual appliances, network functions, virtual nodes, virtual network functions, etc.) operative to implement some of the features, functions, and/or benefits of some of the embodiments disclosed herein. Applications 1220 are run in virtualization environment 1200 which provides hardware 1230 comprising processing circuitry 1260 and memory 1290-1. Memory 1290-1 contains instructions 1295 executable by processing circuitry 1260 whereby application 1220 is operative to provide one or more of the features, benefits, and/or functions disclosed herein.

Virtualization environment 1200, comprises general-purpose or special-purpose network hardware devices 1230 comprising a set of one or more processors or processing circuitry 1260, which may be commercial off-the-shelf (COTS) processors, dedicated Application Specific Integrated Circuits (ASICs), or any other type of processing circuitry including digital or analog hardware components or special purpose processors. Each hardware device may comprise memory 1290-1 which may be non-persistent memory for temporarily storing instructions 1295 or software executed by processing circuitry 1260. Each hardware device may comprise one or more network interface controllers (NICs) 1270, also known as network interface cards, which include physical network interface 1280. Each hardware device may also include non-transitory, persistent, machine-readable storage media 1290-2 having stored therein software 1295 and/or instructions executable by processing circuitry 1260. Software 1295 may include any type of software including software for instantiating one or more virtualization layers 1250 (also referred to as hypervisors), software to execute virtual machines 1240 as well as software allowing it to execute functions, features and/or benefits described in relation with some embodiments described herein.

Virtual machines 1240, comprise virtual processing, virtual memory, virtual networking or interface and virtual storage, and may be run by a corresponding virtualization layer 1250 or hypervisor. Different embodiments of the instance of virtual appliance 1220 may be implemented on one or more of virtual machines 1240, and the implementations may be made in different ways.

During operation, processing circuitry 1260 executes software 1295 to instantiate the hypervisor or virtualization layer 1250, which may sometimes be referred to as a virtual machine monitor (VMM). Virtualization layer 1250 may present a virtual operating platform that appears like networking hardware to virtual machine 1240.

As shown in FIG. 11, hardware 1230 may be a standalone network node with generic or specific components. Hardware 1230 may comprise antenna 12225 and may implement some functions via virtualization. Alternatively, hardware 1230 may be part of a larger cluster of hardware (e.g. such as in a data center or customer premise equipment (CPE)) where many hardware nodes work together and are managed via management and orchestration (MANO) 12100, which, among others, oversees lifecycle management of applications 1220.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1240 may be a software implementation of a physical machine that runs programs as if they were executing on a physical, non-virtualized machine. Each of virtual machines 1240, and that part of hardware 1230 that executes that virtual machine, be it hardware dedicated to that virtual machine and/or hardware shared by that virtual machine with others of the virtual machines 1240, forms a separate virtual network elements (VNE).

Still in the context of NFV, Virtual Network Function (VNF) is responsible for handling specific network functions that run in one or more virtual machines 1240 on top of hardware networking infrastructure 1230 and corresponds to application 1220 in FIG. 11.

In some embodiments, one or more radio units 12200 that each include one or more transmitters 12220 and one or more receivers 12210 may be coupled to one or more antennas 12225. Radio units 12200 may communicate directly with hardware nodes 1230 via one or more appropriate network interfaces and may be used in combination with the virtual components to provide a virtual node with radio capabilities, such as a radio access node or a base station.

In some embodiments, some signalling can be effected with the use of control system 12230 which may alternatively be used for communication between the hardware nodes 1230 and radio units 12200.

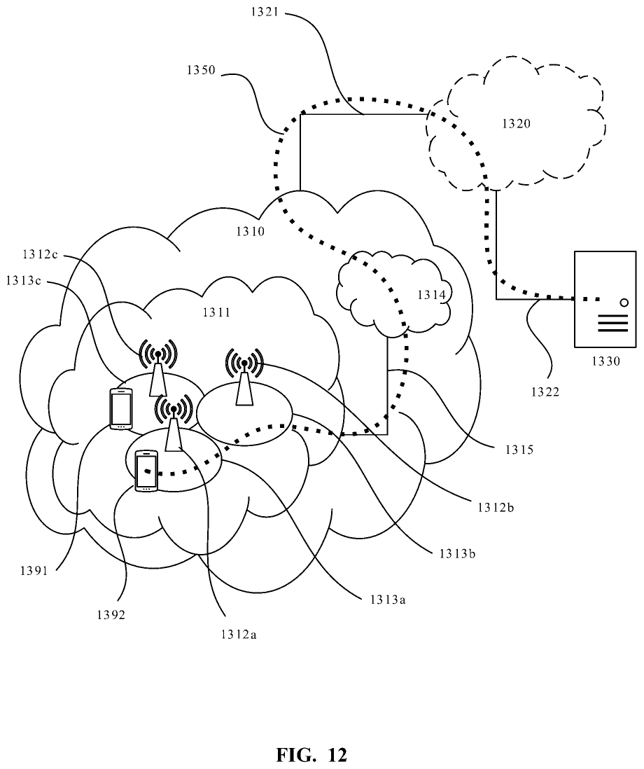

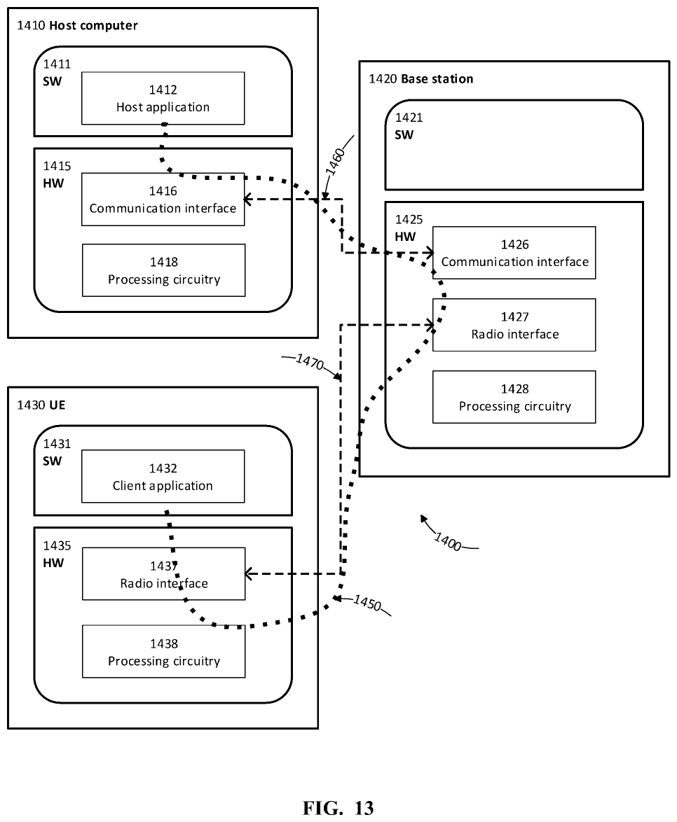

FIG. 12 is a schematic showing a telecommunication network connected via an intermediate network to a host computer in accordance with some embodiments.

With reference to FIG. 12, in accordance with an embodiment, a communication system includes telecommunication network 1310, such as a 3GPP-type cellular network, which comprises access network 1311, such as a radio access network, and core network 1314. Access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to core network 1314 over a wired or wireless connection 1315. A UE 1391 located in coverage area 1313c is configured to wirelessly connect to, or be paged by, the corresponding base station 1312c. A relay UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312a or 1312b or 1312c.

Telecommunication network 1310 is itself connected to host computer 1330, which may be embodied in the hardware and/or software of a standalone server, a cloud-implemented server, a distributed server or as processing resources in a server farm. Host computer 1330 may be under the ownership or control of a service provider, or may be operated by the service provider or on behalf of the service provider. Connections 1321 and 1322 between telecommunication network 1310 and host computer 1330 may extend directly from core network 1314 to host computer 1330 or may go via an optional intermediate network 1320. Intermediate network 1320 may be one of, or a combination of more than one of, a public, private or hosted network; intermediate network 1320, if any, may be a backbone network or the Internet; in particular, intermediate network 1320 may comprise two or more sub-networks (not shown).

The communication system of FIG. 12 as a whole enables connectivity between the connected UEs 1391, 1392 and host computer 1330. The connectivity may be described as an over-the-top (OTT) connection 1350. Host computer 1330 and the connected UEs 1391, 1392 are configured to communicate data and/or signalling via OTT connection 1350, using access network 1311, core network 1314, any intermediate network 1320 and possible further infrastructure (not shown) as intermediaries. OTT connection 1350 may be transparent in the sense that the participating communication devices through which OTT connection 1350 passes are unaware of routing of uplink and downlink communications. For example, base station 1312a or 1312b or 1312c may not or need not be informed about the past routing of an incoming downlink communication with data originating from host computer 1330 to be forwarded (e.g., handed over) to a connected UE 1391. Similarly, base station 1312a or 1312b or 1312c need not be aware of the future routing of an outgoing uplink communication originating from the UE 1391 towards the host computer 1330.

FIG. 13 is a schematic showing a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 13. In communication system 1400, host computer 1410 comprises hardware 1415 including communication interface 1416 configured to set up and maintain a wired or wireless connection with an interface of a different communication device of communication system 1400. Host computer 1410 further comprises processing circuitry 1418, which may have storage and/or processing capabilities. In particular, processing circuitry 1418 may comprise one or more programmable processors, application-specific integrated circuits, field programmable gate arrays or combinations of these (not shown) adapted to execute instructions. Host computer 1410 further comprises software 1411, which is stored in or accessible by host computer 1410 and executable by processing circuitry 1418. Software 1411 includes host application 1412. Host application 1412 may be operable to provide a service to a remote user, such as UE 1430 connecting via OTT connection 1450 terminating at UE 1430 and host computer 1410. In providing the service to the remote user, host application 1412 may provide user data which is transmitted using OTT connection 1450.

Communication system 1400 further includes base station 1420 provided in a telecommunication system and comprising hardware 1425 enabling it to communicate with host computer 1410 and with UE 1430. Hardware 1425 may include communication interface 1426 for setting up and maintaining a wired or wireless connection with an interface of a different communication device of communication system 1400, as well as radio interface 1427 for setting up and maintaining at least wireless connection 1470 with UE 1430 located in a coverage area (not shown in FIG. 13) served by base station 1420. Communication interface 1426 may be configured to facilitate connection 1460 to host computer 1410. Connection 1460 may be direct or it may pass through a core network (not shown in FIG. 13) of the telecommunication system and/or through one or more intermediate networks outside the telecommunication system. In the embodiment shown, hardware 1425 of base station 1420 further includes processing circuitry 1428, which may comprise one or more programmable processors, application-specific integrated circuits, field programmable gate arrays or combinations of these (not shown) adapted to execute instructions. Base station 1420 further has software 1421 stored internally or accessible via an external connection.

Communication system 1400 further includes UE 1430 already referred to. Its hardware 1435 may include radio interface 1437 configured to set up and maintain wireless connection 1470 with a base station serving a coverage area in which UE 1430 is currently located. Hardware 1435 of UE 1430 further includes processing circuitry 1438, which may comprise one or more programmable processors, application-specific integrated circuits, field programmable gate arrays or combinations of these (not shown) adapted to execute instructions. UE 1430 further comprises software 1431, which is stored in or accessible by UE 1430 and executable by processing circuitry 1438. Software 1431 includes client application 1432. Client application 1432 may be operable to provide a service to a human or non-human user via UE 1430, with the support of host computer 1410. In host computer 1410, an executing host application 1412 may communicate with the executing client application 1432 via OTT connection 1450 terminating at UE 1430 and host computer 1410. In providing the service to the user, client application 1432 may receive request data from host application 1412 and provide user data in response to the request data. OTT connection 1450 may transfer both the request data and the user data. Client application 1432 may interact with the user to generate the user data that it provides.

It is noted that host computer 1410, base station 1420 and UE 1430 illustrated in FIG. 13 may be similar or identical to host computer 1330, one of base stations 1312a, 1312b, 1312c and one of UEs 1391, 1392 of FIG. 12, respectively. This is to say, the inner workings of these entities may be as shown in FIG. 13 and independently, the surrounding network topology may be that of FIG. 12.

In FIG. 13, OTT connection 1450 has been drawn abstractly to illustrate the communication between host computer 1410 and UE 1430 via base station 1420, without explicit reference to any intermediary devices and the precise routing of messages via these devices. Network infrastructure may determine the routing, which it may be configured to hide from UE 1430 or from the service provider operating host computer 1410, or both. While OTT connection 1450 is active, the network infrastructure may further take decisions by which it dynamically changes the routing (e.g., on the basis of load balancing consideration or reconfiguration of the network).

Wireless connection 1470 between UE 1430 and base station 1420 is in accordance with the teachings of the embodiments described throughout this disclosure. One or more of the various embodiments improve the performance of OTT services provided to UE 1430 using OTT connection 1450, in which wireless connection 1470 forms the last segment. More precisely, in some embodiments herein, it may enable the CAS to know the selected EES in EDN. In some embodiments herein, it provides functionality in EDGEAPP to support service continuity. In some embodiments herein, it enables the CAS to utilize the needed EEL service for instance subscribe to receive ACT status notifications in S-EES executed ACR scenario for EELManagedACR and/or trigger CAS decided ACR. In some embodiments herein, it solves the issue when CAS needs to relocate application context but doesn't know the EES to start T-EAS discovery and selected T-EAS declaration procedures. In some embodiments herein, it also allows the CAS to contact the EES (e.g. ACR facilitation as described in 3GPP TS 23.558 V17.3.0, clause 8.6.3 and clause 8.8.2.5) to start with EES executed ACR scenario.

A measurement procedure may be provided for the purpose of monitoring data rate, latency and other factors on which the one or more embodiments improve. There may further be an optional network functionality for reconfiguring OTT connection 1450 between host computer 1410 and UE 1430, in response to variations in the measurement results. The measurement procedure and/or the network functionality for reconfiguring OTT connection 1450 may be implemented in software 1411 and hardware 1415 of host computer 1410 or in software 1431 and hardware 1435 of UE 1430, or both. In embodiments, sensors (not shown) may be deployed in or in association with communication devices through which OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of OTT connection 1450 may include message format, retransmission settings, preferred routing etc.; the reconfiguring need not affect base station 1420, and it may be unknown or imperceptible to base station 1420. Such procedures and functionalities may be known and practiced in the art. In certain embodiments, measurements may involve proprietary UE signalling facilitating host computer 1410's measurements of throughput, propagation times, latency and the like. The measurements may be implemented in that software 1411 and 1431 causes messages to be transmitted, in particular empty or ‘dummy’ messages, using OTT connection 1450 while it monitors propagation times, errors etc.

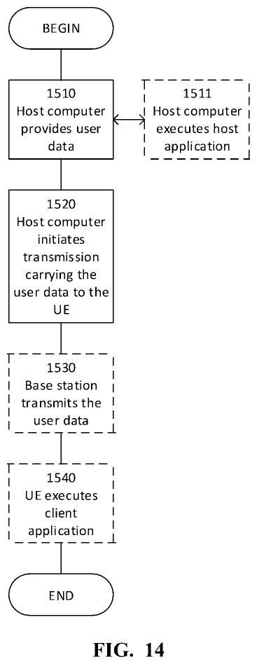

FIG. 14 is a schematic showing methods implemented in a communication system including a host computer, a base station and a user equipment in accordance with some embodiments.

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step 1510, the host computer provides user data. In substep 1511 (which may be optional) of step 1510, the host computer provides the user data by executing a host application. In step 1520, the host computer initiates a transmission carrying the user data to the UE. In step 1530 (which may be optional), the base station transmits to the UE the user data which was carried in the transmission that the host computer initiated, in accordance with the teachings of the embodiments described throughout this disclosure. In step 1540 (which may also be optional), the UE executes a client application associated with the host application executed by the host computer.

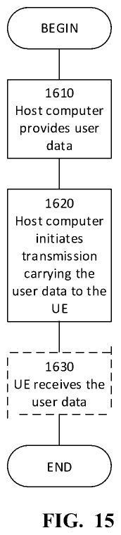

FIG. 15 is a schematic showing methods implemented in a communication system including a host computer, a base station and a user equipment in accordance with some embodiments.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 1610 of the method, the host computer provides user data. In an optional substep (not shown) the host computer provides the user data by executing a host application. In step 1620, the host computer initiates a transmission carrying the user data to the UE. The transmission may pass via the base station, in accordance with the teachings of the embodiments described throughout this disclosure. In step 1630 (which may be optional), the UE receives the user data carried in the transmission.

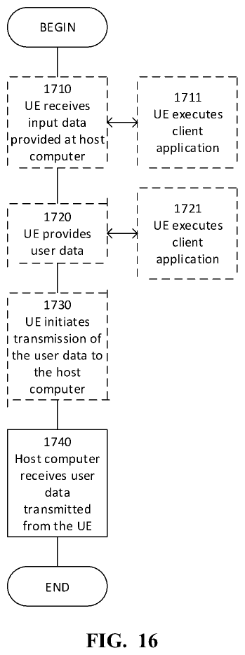

FIG. 16 is a schematic showing methods implemented in a communication system including a host computer, a base station and a user equipment in accordance with some embodiments.

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 1710 (which may be optional), the UE receives input data provided by the host computer. Additionally or alternatively, in step 1720, the UE provides user data. In substep 1721 (which may be optional) of step 1720, the UE provides the user data by executing a client application. In substep 1711 (which may be optional) of step 1710, the UE executes a client application which provides the user data in reaction to the received input data provided by the host computer. In providing the user data, the executed client application may further consider user input received from the user. Regardless of the specific manner in which the user data was provided, the UE initiates, in substep 1730 (which may be optional), transmission of the user data to the host computer. In step 1740 of the method, the host computer receives the user data transmitted from the UE, in accordance with the teachings of the embodiments described throughout this disclosure.

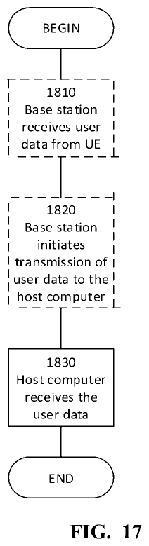

FIG. 17 is a schematic showing methods implemented in a communication system including a host computer, a base station and a user equipment in accordance with some embodiments.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 1810 (which may be optional), in accordance with the teachings of the embodiments described throughout this disclosure, the base station receives user data from the UE. In step 1820 (which may be optional), the base station initiates transmission of the received user data to the host computer. In step 1830 (which may be optional), the host computer receives the user data carried in the transmission initiated by the base station.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1-97. (canceled)

98. A method performed by a cloud application server (CAS), the method comprising:
receiving a first request from an edge enabler server (EES) selected for an edge enabler client (EEC) of a user equipment (UE) during a procedure of application context relocation (ACR) or after the EES receiving an edge application server (EAS) information provisioning request, wherein the first request comprises endpoint information of the EES; and
storing the endpoint information of the EES.

99. The method according to claim 98, wherein the endpoint information of the EES comprises at least one of:
a Uniform Resource Identifier (URI),
a Fully Qualified Domain Name (FQDN), or
an Internet protocol address.

100. The method according to claim 98, wherein the first request is a selected EES declaration request.

101. The method according to claim 98, wherein the ACR is between an edge application server (EAS) and the CAS.

102. The method according to claim 98, wherein,
the ACR is initiated by the EEC, using regular EAS discovery, and/or
the ACR is executed by the EEC via the EES, and/or
the ACR is decided by a source EAS, and/or
the ACR is executed by the EES.

103. A method performed by an edge enabler server (EES) selected for an edge enabler client (EEC) of a user equipment (UE), the method comprising:
sending a first request to a cloud application server (CAS) during a procedure of application context relocation (ACR) or after the EES receiving an edge application server (EAS) information provisioning request, wherein the first request comprises endpoint information of the EES.

104. The method according to claim 103, wherein the first request is a selected EES declaration request.

105. The method according to claim 103, further comprising:
receiving a first response from the CAS.

106. The method according to claim 103, wherein the ACR is between an edge application server (EAS) and the CAS.

107. The method according to claim 103, wherein,
the ACR is initiated by the EEC, using regular EAS discovery, and/or
the ACR is executed by the EEC via the EES, and/or
the ACR is decided by a source EAS, and/or
the ACR is executed by the EES.

108. The method according to claim 103, further comprising:
receiving a first ACR request from the EEC, wherein the first ACR request comprises information based on which the EES informs the CAS with the endpoint information of the EES.

109. The method according to claim 103, further comprising:
receiving a selected CAS declaration message from a source EAS, wherein the selected CAS declaration message informs the EES a determined CAS to use.

110. A method performed by an edge enabler client (EEC), the method comprising:
sending a first application context relocation (ACR) request to an edge enabler server (EES) selected for the EEC of a user equipment (UE) during a procedure of ACR, wherein the first ACR request comprises information based on which the EES informs a cloud application server (CAS) with endpoint information of the EES.

111. The method according to claim 110, wherein the endpoint information of the EES comprises at least one of:
a Uniform Resource Identifier (URI),
a Fully Qualified Domain Name (FQDN), or
an Internet protocol address.

112. The method according to claim 110, wherein the ACR is between an edge application server (EAS) and the CAS.

113. The method according to claim 110, wherein,
the ACR is initiated by the EEC, using regular EAS discovery, and/or
the ACR is executed by EEC via the EES.

114. The method according to claim 110, wherein the endpoint information of the EES is used by the CAS to communicate with the EES to at least one of:
communicate with the EES to start a target EAS discovery procedure,
trigger a service continuity procedure towards the selected EES,
subscribe to receive application context transfer status notification, or
subscribe to receive ACR management notification.

115. The method according to claim 110, further comprising:
receiving a second ACR request from an application client (AC), wherein the second ACR request comprises information indicating that an included target EAS is CAS.

116. The method according to claim 110, wherein the CAS is found out via Domain Name System (DNS) query/discovery.

117. An edge enabler client (EEC), the EEC comprising:
a processor; and
a memory coupled to the processor, said memory containing instructions executable by said processor, whereby the EEC is operative to:
send a first application context relocation (ACR) request to an edge enabler server (EES) selected for the EEC of a user equipment (UE) during a procedure of ACR, wherein a first ACR request comprises information based on which the EES informs a cloud application server (CAS) with endpoint information of the EES.
